(19) United States
(12) Patent Application Publication
(10) Pub. No.: US 2025/0306483 A1
(43) Pub. Date: Oct. 2, 2025

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Eiji KAWAKAMI, Kanagawa (JP); Narumasa SATO, Kanagawa (JP); Daisuke ISHIZUKA, Kanagawa (JP); Mako TSUCHIYA, Kanagawa (JP)

(73) Assignee: FUJIFILM Business Innovation Corp., Tokyo (JP)

(21) Appl. No.: 19/023,130

(22) Filed: Jan. 15, 2025

(30) Foreign Application Priority Data
Mar. 27, 2024 (JP) 2024-052553

(51) Int. Cl. G03G 9/08; G03G 9/087

(52) U.S. Cl. CPC G03G 9/0819; G03G 9/0821; G03G 9/08755; G03G 2215/0604; G03G 2215/066; G03G 2221/183

(57) ABSTRACT

An electrostatic charge image developing toner contains toner particles that contain an amorphous polyester resin and a crystalline polyester resin as a binder resin and internally-added crosslinked resin particles, in which the internally-added crosslinked resin particles are styrene-(meth)acrylic copolymer particles in which a storage elastic modulus G′ in a range of 60° C. or higher and 100° C. or lower is 1×10⁵ Pa or more and 1×10⁶ Pa or less, an average dispersion size of the internally-added crosslinked resin particles is 100 nm or more and 300 nm or less, and in a case where a square region of 3 μm×3 μm having a size of 600 pix×600 pix in a cross-sectional observation of the toner particles is divided into n×n regions, in the n×n divided regions, the following expression (1) is satisfied from DAR(n) that is a coefficient of variation of an area ratio of the internally-added crosslinked resin particles to an area of the divided regions and slope F(16) that is a slope of an approximate straight line in a dispersion diagram obtained by changing the n to 3, 4, 6, 8, 12, and 16 and plotting log [1/n] on an X-axis and log [DAR(n)] on a Y-axis.

0.6≤slope F(16) Expression (1):

### CROSS-REFERENCE TO RELATED APPLICATIONS

This application is based on and claims priority under 35 USC 119 from Japanese Patent Application No. 2024-052553 filed Mar. 27, 2024.

### BACKGROUND

### (i) Technical Field

The present invention relates to an electrostatic charge image developing toner, an electrostatic charge image developer, a toner cartridge, a process cartridge, an image forming apparatus, and an image forming method.

### (ii) Related Art

JP2023-048127A discloses “electrostatic charge image developing toner containing toner particles that contains a binder resin, in which, in a dynamic viscoelasticity measurement of the electrostatic image developing toner, in a case where a loss tangent tan δ at a temperature of 90° C. and a strain of 1% is defined as D1(90), a loss tangent tan δ at a temperature of 90° C. and a strain of 50% is defined as D50(90), a loss tangent tan δ at a temperature of 150° C. and a strain of 1% is defined as D1(150), and a loss tangent tan δ at a temperature of 150° C. and a strain of 50% is defined as D50(150), D1(90), D50(90), D1(150), and D50(150) are each 0.5 or more and 2.5 or less, a value of D50(150)−D1(150) is less than 1.5, a value of D50(90)−D1(90) is less than 1.0, the toner particles further contain resin particles, and a number-average molecular weight of tetrahydrofuran-soluble components in the toner particles is 5,000 or more and 15,000 or less”.

JP2020-046499A discloses “electrostatic charge image developing toner containing a binder resin and rubber particles, in which a compression permanent strain of the rubber particles at a temperature at which a melting viscosity of the toner reaches 104 Pa is 20% or more and 50% or less”.

JP2016-062042A discloses “electrostatic charge image developing toner containing toner particles that contains a binder resin including a polyester resin, a release agent that includes a hydrocarbon-based wax, and a styrene (meth)acrylic resin, in which 70% or more of the release agent is present within 800 nm from a surface of the toner particles, and the styrene (meth)acrylic resin in the toner particles forms a domain having an average size of less than 0.3 μm”.

JP2020-160204A discloses “electrostatic charge image developing toner including a continuous phase that contains at least a binder resin, and a discontinuous phase that is dispersed in the continuous phase and includes a core portion including the binder resin and a coating layer covering the core portion and including the binder resin”.

JP2016-062040A discloses “electrostatic charge image developing toner containing toner particles that contains a binder resin including a polyester resin, a release agent that includes a hydrocarbon-based wax, and a styrene (meth)acrylic resin, in which 70% or more of the release agent is present within 800 nm from a surface of the toner particles, the styrene (meth)acrylic resin in the toner particles forms a domain having an average size of 0.3 μm or more and 0.8 μm or less, and a proportion of the number of the domains included in a range of the average size±0.1 μm is 65% or more”.

### SUMMARY

Aspects of non-limiting embodiments of the present disclosure relate to an electrostatic charge image developing toner that contains toner particles that contain an amorphous polyester resin and a crystalline polyester resin as a binder resin and internally-added crosslinked resin particles, where the electrostatic charge image developing toner can suppress transfer unevenness in a high-temperature and high-humidity environment while having low-temperature fixability, as compared with a case where the internally-added crosslinked resin particles are styrene-(meth)acrylic copolymer particles in which a storage elastic modulus G′ in a range of 60° C. or higher and 100° C. or lower is less than 1×10⁵ Pa or more than 1×10⁶ Pa, a case where an expression (1) is not satisfied, or a case where an average dispersion size of the internally-added crosslinked resin particles is less than 100 nm or more than 300 nm or less.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described

Methods for achieving the above object include the following an aspect.

According to an aspect of the present disclosure, there is provided an electrostatic charge image developing toner containing toner particles that contain an amorphous polyester resin and a crystalline polyester resin as a binder resin and internally-added crosslinked resin particles, in which the internally-added crosslinked resin particles are styrene-(meth)acrylic copolymer particles in which a storage elastic modulus G′ in a range of 60° C. or higher and 100° C. or lower is 1×10⁵ Pa or more and 1×10⁶ Pa or less, an average dispersion size of the internally-added crosslinked resin particles is 100 nm or more and 300 nm or less, and in a case where a square region of 3 μm×3 μm having a size of 600 pix×600 pix in a cross-sectional observation of the toner particles is divided into n×n regions, in the n×n divided regions, the following expression (1) is satisfied from DAR(n) that is a coefficient of variation of an area ratio of the internally-added crosslinked resin particles to an area of the divided regions and slope F(16) that is a slope of an approximate straight line in a dispersion diagram obtained by changing the n to 3, 4, 6, 8, 12, and 16 and plotting log[1/n] on an X-axis and log[DAR(n)] on a Y-axis,

0.6≤slope F(16). expression (1):

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

Hereinafter, exemplary embodiments of the present invention will be described. The following descriptions and examples merely illustrate the exemplary embodiments, and do not limit the scope of the invention.

Regarding the numerical ranges described in stages in the present specification, the upper limit value or lower limit value of a numerical range may be replaced with the upper limit value or lower limit value of another numerical range described in stages. In addition, in the present specification, the upper limit value or lower limit value of a numerical range may be replaced with values described in examples.

In the present specification, (meth)acrylic means both acrylic and methacrylic.

In the present specification, the term “step” includes not only an independent step but a step that is not clearly distinguished from other steps as long as the intended purpose of the step is achieved.

Each component may include a plurality of corresponding substances.

In a case where the amount of each component in a composition is mentioned, and there are two or more kinds of substances corresponding to each component in the composition, unless otherwise specified, the amount of each component means the total amount of two or more kinds of the substances present in the composition.

### Electrostatic Charge Image Developing Toner

The electrostatic charge image developing toner (hereinafter, also referred to as “toner”) according to the present exemplary embodiment has toner particles that contain an amorphous polyester resin and a crystalline polyester resin as a binder resin and internally-added crosslinked resin particles.

The internally-added crosslinked resin particles are styrene-(meth)acrylic copolymer particles in which a storage elastic modulus G′ in a range of 60° C. or higher and 100° C. or lower is 1×10⁵ Pa or more and 1×10⁶ Pa or less.

An average dispersion size of the internally-added crosslinked resin particles is 100 nm or more and 300 nm or less.

In a case where a square region of 3 μm×3 μm having a size of 600 pix×600 pix in a cross-sectional observation of the toner particles is divided into n×n regions, in the n×n divided regions, the following expression (1) is satisfied from DAR(n) that is a coefficient of variation of an area ratio of the internally-added crosslinked resin particles to an area of the divided regions and slope F(16) that is a slope of an approximate straight line in a dispersion diagram obtained by changing the n to 3, 4, 6, 8, 12, and 16 and plotting log[1/n] on an X-axis and log[DAR(n)] on a Y-axis.

With the above-described configuration, the toner according to the present exemplary embodiment can suppress transfer unevenness in a high-temperature and high-humidity environment (for example, an environment at a temperature of 28° C. and a relative humidity of 85% RH) while having low-temperature fixability. The reason is presumed as follows.

In the related art, in order to achieve both low-temperature fixability and thermal storage stability, a toner obtained by using an amorphous polyester resin and a crystalline polyester resin in combination is known. However, since the crystalline polyester resin has a lower resistance than the amorphous polyester resin, in a case where the crystalline polyester resin is contained, a domain of the crystalline polyester resin grows inside the toner particles, and it is easy to form a conduction path in the toner. Furthermore, in a high-temperature and high-humidity environment (for example, an environment at a temperature of 28° C. and a relative humidity of 85% RH), the decrease in resistance due to the temperature and the humidity influence makes the toner more conductive, and thus charge injection properties deteriorate, resulting in a decrease in transferability and the occurrence of transfer unevenness in the obtained image.

In order to improve the decrease in transferability, for example, it is preferable to keep the domain of the crystalline polyester resin inside the toner particles small.

However, for example, in the related art, a technique of containing internally-added crosslinked resin particles in the inside of the toner particles is known (JP2023-048127A and the like). In a case where the internally-added crosslinked resin particles are present, the growth of the domain of the crystalline polyester resin may be partially suppressed, but disposition of the internally-added crosslinked resin particles and the crystalline polyester resin cannot be controlled during production of the toner particles, and the growth of the domain of the crystalline polyester resin is not easily suppressed.

Here, in order to appropriately dispose the internally-added crosslinked resin particles and the crystalline polyester resin inside the toner particles, for example, it is particularly preferable to produce the toner particles by an emulsification aggregation method. In the emulsification aggregation method, amorphous polyester resin particles, crystalline polyester resin particles, and internally-added crosslinked resin particles are dispersed in water and aggregated to form a structure of the toner particles. In the process of forming the toner particles, for example, it is preferable that the internally-added crosslinked resin particles and the crystalline polyester resin particles are aggregated in the vicinity of each other, and the state thereof is maintained until a fusion step of the toner particles is completed.

In the toner of the related art, a temperature just above the room temperature is equal to or higher than a glass transition temperature of the internally-added crosslinked resin particles, and lower than a glass transition temperature of the amorphous polyester resin. In this case, only the internally-added crosslinked resin particles have strong adhesiveness and are likely to aggregate alone, and the internally-added crosslinked resin particles are unevenly distributed in the aggregated particles. As a result, the number of internally-added crosslinked resin particles present near the crystalline polyester resin is reduced, and the factor that inhibits the growth of the domain of the crystalline polyester resin in a temperature range near a melting point of the crystalline polyester resin is reduced. In this way, the crystalline polyester resin has a structure in which the conduction path is easily formed due to the easy growth of the domain, and the charge injection properties of the toner particles deteriorate in the high-temperature and high-humidity environment. As a result, the transfer unevenness occurs.

On the other hand, in the toner according to the present exemplary embodiment, since the internally-added crosslinked resin particles have an appropriate size by setting the average dispersion size of the internally-added crosslinked resin particles within the above-described range, the internally-added crosslinked resin particles are dispersed in the toner particles in a state close to being uniform such that the expression (1) is satisfied. As a result, the internally-added crosslinked resin particles are appropriately present in the vicinity of the crystalline polyester, that inhibits the growth of the domain of the crystalline polyester resin and makes it difficult for the crystalline polyester domain to grow.

In addition, the internally-added crosslinked resin particles having the above-described storage elastic modulus G′ have elastic properties at a high temperature in a range of 60° C. or higher and 100° C. or lower. Therefore, in the coalescence step of the emulsification aggregation method, the internally-added crosslinked resin particles can be present in the toner particles in a state close to being uniform without being fused and forming a domain with each other, and the movement of the crystalline polyester resin and the growth of the domain can be suppressed.

As a result, in the high-temperature and high-humidity environment, deterioration of the charge injection properties of the toner particles is suppressed, and the occurrence of transfer unevenness is suppressed.

From the above, it is presumed that the toner according to the present exemplary embodiment can suppress transfer unevenness in a high-temperature and high-humidity environment while having low-temperature fixability.

Hereinafter, the toner according to the present exemplary embodiment will be described in detail.

The toner according to the present exemplary embodiment has toner particles. The toner according to the present exemplary embodiment may have an external additive.

### Toner Particles

The toner particles contain an amorphous resin and a crystalline resin as a binder resin, and internally-added crosslinked resin particles. The toner particles may contain a colorant, a release agent, and other additives.

### Binder Resin

As the binder resin, an amorphous polyester resin and a crystalline polyester resin are adopted as the binder resin.

However, from the viewpoint of ensuring the low-temperature fixability and suppressing the transfer unevenness in a high-temperature and high-humidity environment, a content of the crystalline polyester resin with respect to the binder resin is, for example, preferably 10% by mass or more and 40% by mass or less, more preferably 10% by mass or more and 30% by mass or less, and still more preferably 15% by mass or more and 20% by mass or less.

In a case where the content of the crystalline polyester resin is less than 10% by mass, the low-temperature fixability is likely to be deteriorated.

In a case where the content of the crystalline polyester resin is more than 40% by mass, it is difficult to suppress the growth of the domain of the crystalline polyester resin, and the transfer unevenness is likely to occur in the high-temperature and high-humidity environment.

The “crystalline” resin indicates that a clear endothermic peak is present in differential scanning calorimetry (DSC) rather than a stepwise change in endothermic amount and specifically indicates that the half-width of the endothermic peak in a case of measurement at a temperature rising rate of 10 (° C./min) is within 10° C.

On the other hand, the “amorphous” resin indicates that the half-width is higher than 10° C., a stepwise change in endothermic amount is shown, or a clear endothermic peak is not recognized.

The amorphous polyester resin will be described.

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC·HLC-8120GPC manufactured by Tosoh Corporation as a measurement device, TSKgel Super HM-M (15 cm) manufactured by Tosoh Corporation as a column, and THE as a solvent. The weight-average molecular weight and the number-average molecular weight are calculated using a molecular weight calibration curve plotted using a monodisperse polystyrene standard sample from the measurement results.

The amorphous polyester resin is obtained by a well-known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the reaction, for example, the monomer with poor compatibility may be condensed in advance with an acid or an alcohol that is to be polycondensed with the monomer, and then polycondensed together with the principle component.

Here, one kind of amorphous polyester resin may be used alone, or two or more kinds of amorphous polyester resins may be used in combination.

For example, it is preferable that the amorphous polyester resin obtained by using two or more kinds of amorphous polyesters having different molecular weights in combination. Examples of the case of using two kinds in combination include a case of using a low-molecular-weight form (L form) of the amorphous polyester resin and a high-molecular-weight form (H form) of the amorphous polyester resin in combination.

The low-molecular-weight form (L form) is, for example, preferably an amorphous polyester resin having a weight-average molecular weight of 9,000 or more and 20,000 or less, which is measured by GPC. In a case where the molecular weight is less than 9,000, offset is likely to occur in a high-temperature portion; and in a case where the molecular weight is 20,000 or more, gloss is unlikely to be obtained in a low-temperature portion.

The high-molecular-weight form (H form) is, for example, preferably an amorphous polyester resin having a polymerization average molecular weight of 25,000 or more and 70,000 or less, which is measured by GPC. In a case where the molecular weight is 70,000 or more, gloss in a high-temperature portion is difficult to obtain, or a fixing temperature is increased.

An acid value of the amorphous polyester resin used in combination is, for example, preferably approximately 13 mgKOH/g or more and 20 mgKOH/g or less for the low-molecular-weight form (L form) and approximately 10 mgKOH/g or more and 15 mgKOH/g or less for the high-molecular-weight form (H form).

The crystalline polyester resin will be described.

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the aliphatic diols, for example, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

The melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The weight-average molecular weight (Mw) of the crystalline polyester resin is, for example, preferably 6,000 or more and 35,000 or less.

The crystalline polyester resin can be obtained by a well-known manufacturing method, for example, same as the amorphous polyester resin.

A content of the binder resin with respect to the total amount of the toner particles is, for example, preferably 40% by mass or more and 95% by mass or less, more preferably 50% by mass or more and 90% by mass or less, and still more preferably 60% by mass or more and 85% by mass or less.

### Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

One kind of colorant may be used alone, or two or more kinds of colorants may be used in combination.

Here, the carbon black as the colorant has conductivity, and in a case where the domain of the crystalline polyester resin grows, the conduction path is easily formed between the carbon black and the crystalline polyester resin, particularly inside the toner particles. As a result, the transferability is degraded, and the degradation appears as the transfer unevenness in an image to be obtained in a high-temperature and high-humidity environment.

However, in the toner according to the present exemplary embodiment, even in a case where the carbon black is applied as the colorant, the conduction path is unlikely to be formed inside the toner particles, and the transfer unevenness in a high-temperature and high-humidity environment is suppressed.

As the colorant, a colorant having undergone a surface treatment as necessary may be used, or a dispersant may be used in combination with the colorant. Furthermore, a plurality of kinds of colorants may be used in combination.

The content of the colorant with respect to the total amount of the toner particles is, for example, preferably 1% by mass or more and 30% by mass or less, and more preferably 3% by mass or more and 15% by mass or less.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Internally-Added Crosslinked Resin Particles

The internally-added crosslinked resin particles refer to resin particles that are contained inside the toner particles have a bridge structure between specific atoms in a polymer structure of the resin particles.

The internally-added crosslinked resin particles are, for example, particles that are present in the toner particles in a state of being incompatible with the binder resin.

Examples of the internally-added crosslinked resin particles include crosslinked resin particles crosslinked by an ionic bond (that is, ionically crosslinked resin particles), and crosslinked resin particles crosslinked by a covalent bond (that is, covalently crosslinked resin particles). Among these internally-added crosslinked resin particles, for example, crosslinked resin particles crosslinked by a covalent bond are preferable.

As the internally-added crosslinked resin particles, styrene-(meth)acrylic copolymer particles in which a storage elastic modulus G′ in a range of 60° C. or higher and 100° C. or lower is 1×10⁵ Pa or more and 1×10⁶ Pa or less are applied.

In a case where the storage elastic modulus G′ of the styrene-(meth)acrylic copolymer particles as the internally-added crosslinked resin particles is less than 1×10⁵ Pa, viscosity of the internally-added crosslinked resin particles increases, and the internally-added crosslinked resin particles adhere to and fuse with each other, and thus a structure satisfying the expression (1) cannot be obtained. As a result, the transfer unevenness occurs in a high-temperature and high-humidity environment.

In a case where the storage elastic modulus G′ of the styrene-(meth)acrylic copolymer particles as the internally-added crosslinked resin particles is more than 1×10⁶ Pa, the internally-added crosslinked resin particles are too hard, and the low-temperature fixability of the toner is impaired.

In order to set the storage elastic modulus G′ of the styrene-(meth)acrylic copolymer particles as the internally-added crosslinked resin particles within the above-described range, for example, a ratio of a styrene-based monomer and a (meth)acrylic monomer, and a crosslinking amount are adjusted to suitable ranges.

A method for measuring the storage elastic modulus G′ of the styrene-(meth)acrylic copolymer particles as the internally-added crosslinked resin particles is as follows.

By applying pressure to the internally-added crosslinked resin particles as a measurement target, a disk-shaped sample having a thickness of 2 mm and a diameter of 8 mm is produced, and used as a measurement sample. In a case of measuring the internally-added crosslinked resin particles contained in the toner particles, the internally-added crosslinked resin particles are isolated from the toner particles, and then used for producing the measurement sample. Examples of the method for isolating the internally-added crosslinked resin particles from the toner particles include a method of immersing the toner particles in a solvent that dissolves the binder resin and does not dissolve the internally-added crosslinked resin particles, and dissolving the binder resin in the solvent so as to isolate the internally-added crosslinked resin particles.

The obtained disk-shaped sample as the measurement sample is interposed between parallel plates having a diameter of 8 mm, and dynamic viscoelasticity is measured under the following conditions by raising the measurement temperature from 10° C. to 150° C. at 2° C./min at a strain of 0.1% to 100%. From each storage elastic modulus curve obtained by the measurement, the storage elastic modulus G′ is determined.

### Measurement Conditions

Measurement device: rheometer ARES-G2 (manufactured by TA Instruments)
Gap: adjusted to 3 mm
Frequency: 1 Hz

The styrene-(meth)acrylic copolymer particles as the internally-added crosslinked resin particles are particles containing, as a principle component, a styrene-(meth)acrylic copolymer in resin particles with an amount of 50% by mass or more, for example, preferably 80% by mass or more and more preferably 90% by mass or more, and it is particularly preferable to be particles that are substantially the styrene-(meth)acrylic copolymer.

In addition, the total of styrene-based monomer and (meth)acrylic monomer as monomers constituting the copolymer is, for example, preferably 80% by mass or more, more preferably 90% by mass or more, and particularly preferably 95% by mass or more. The remainder is a crosslinking agent described later.

Examples of the styrene-(meth)acrylic copolymer include a resin obtained by polymerizing the following styrene-based monomer and (meth)acrylic monomer by radical polymerization.

Examples of the styrene-based monomer include styrene, α-methylstyrene, vinylnaphthalene; alkyl-substituted styrene with an alkyl chain, such as 2-methylstyrene, 3-methylstyrene, 4-methylstyrene, 2-ethylstyrene, 3-ethylstyrene, and 4-ethylstyrene; halogen-substituted styrene such as 2-chlorostyrene, 3-chlorostyrene, and 4-chlorostyrene; and fluorine-substituted styrene such as 4-fluorostyrene and 2,5-difluorostyrene. Among the styrene-based monomers, for example, styrene or α-methylstyrene is preferable.

Examples of the (meth)acrylic monomer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, 2-carboxyethyl (meth)acrylate, (meth)acrylonitrile, and (meth)acrylamide. Among these, for example, n-butyl (meth)acrylate or 2-carboxyethyl (meth)acrylate is preferable.

In the internally-added crosslinked resin particles, examples of a crosslinking agent for crosslinking the resin include aromatic polyvalent vinyl compounds such as divinylbenzene and divinylnaphthalene; polyvalent vinyl esters of aromatic polyvalent carboxylic acids, such as divinyl phthalate, divinyl isophthalate, divinyl terephthalate, divinyl homophthalate, divinyl trimesate, trivinyl trimesate, divinyl naphthalenedicarboxylate, and divinyl biphenylcarboxylate; divinyl esters of nitrogen-containing aromatic compounds, such as divinyl pyridine dicarboxylate; vinyl esters of unsaturated heterocyclic carboxylic acid compounds, such as vinyl pyromutate, vinyl furan carboxylate, vinyl pyrrole-2-carboxylate, and vinyl thiophene carboxylate; (meth)acrylic acid esters of linear polyhydric alcohols, such as butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, dodecanediol diacrylate, and dodecanediol dimethacrylate; (meth)acrylic acid esters of branched substituted polyhydric alcohols, such as neopentylglycol dimethacrylate and 2-hydroxy,1,3-diacryloxypropane; and polyvalent vinyl esters of polyvalent carboxylic acids, such as polyethylene glycol di(meth)acrylate, polypropylene polyethylene glycol di(meth)acrylates, divinyl succinate, divinyl fumarate, vinyl maleate, divinyl maleate, divinyl diglycolate, vinyl itaconate, divinyl itaconate, divinyl acetone dicarboxylate, divinyl glutarate, 3,3′-divinylthiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. One kind of crosslinking agent may be used alone, or two or more kinds of crosslinking agents may be used in combination.

Among these crosslinking agents, for example, it is preferable to use a bifunctional alkyl acrylate having an alkylene chain having 6 or more carbon atoms as the crosslinking agent for crosslinking the resin. That is, for example, the internally-added crosslinked resin particles preferably have a bifunctional alkyl acrylate as a constitutional unit, and the number of carbon atoms in the alkylene chain of the bifunctional alkyl acrylate is 6 or more.

By using internally-added crosslinked resin particles having the bifunctional alkyl acrylate as a constitutional unit, in which the number of carbon atoms in the alkylene chain is 6 or more, it is easy to obtain a toner in which the deformation of the toner during fixing is in an appropriate range, and in particular, a toner having favorable low-temperature fixability can be easily obtained. In a case where a crosslinking density of the internally-added crosslinked resin particles is high (that is, a distance between crosslinking points is short), elasticity is too high, but in a case where a bifunctional acrylate having a long alkylene chain is used as the crosslinking agent, the crosslinking density is low (that is, the distance between crosslinking points is long), and it is possible to prevent the elasticity of the internally-added crosslinked resin particles from being too high.

From the viewpoint of adjusting the crosslinking density to an appropriate range, the number of carbon atoms in the alkylene chain of the bifunctional alkyl acrylate is, for example, preferably 6 or more, more preferably 6 or more and 12 or less, and even more preferably 8 or more and 12 or less. More specific examples of the bifunctional alkyl acrylate include 1,6-hexanediol acrylate, 1,6-hexanediol methacrylate, 1,8-octanediol diacrylate, 1,8-octanediol dimethacrylate, 1,9-nonanediol diacrylate, 1,9-nonanediol dimethacrylate, 1,10-decanediol diacrylate, 1,10-decanediol dimethacrylate, 1,12-dodecanediol diacrylate, and 1,12-dodecanediol dimethacrylate, and among these, for example, 1,10-decanediol diacrylate or 1,10-decanediol dimethacrylate is preferable.

Examples of other crosslinking agents include 2-carboxyethyl acrylate, and for example, it is preferable to use at least one of the above-described bifunctional alkyl acrylate or 2-carboxyethyl acrylate.

In addition, the fixability of the styrene-(meth)acrylic copolymer particles as the internally-added crosslinked resin particles may be controlled by adjusting the amount of the crosslinking agent contained in a composition. For example, by increasing the amount of the crosslinking agent contained in the composition, it is easy to obtain internally-added crosslinked resin particles having favorable fixability. The content of the crosslinking agent in the composition for forming the internally-added crosslinked resin particles with respect to the total of 100 parts by mass of the styrene-based monomer, the (meth)acrylic monomer, and the crosslinking agent is, for example, preferably 0.3 parts by mass or more and 5.0 parts by mass or less, more preferably 0.5 parts by mass or more and 3.0 parts by mass or less, and still more preferably 0.8 parts by mass or more and 2.5 parts by mass or less.

A glass transition temperature Tg(E) of the internally-added crosslinked resin particles is, for example, preferably 10° C. or higher and 40° C. or lower, and more preferably 15° C. or higher and 35° C. or lower.

A method for measuring the glass transition temperature Tg(E) of the internally-added crosslinked resin particles is as follows.

By applying pressure to the internally-added crosslinked resin particles as a measurement target, a disk-shaped sample having a thickness of 2 mm and a diameter of 8 mm is produced, and used as a measurement sample. In a case of measuring the internally-added crosslinked resin particles contained in the toner particles, the internally-added crosslinked resin particles are isolated from the toner particles, and then used for producing the measurement sample. Examples of the method for isolating the internally-added crosslinked resin particles from the toner particles include a method of immersing the toner particles in a solvent that dissolves the binder resin and does not dissolve the internally-added crosslinked resin particles, and dissolving the binder resin in the solvent so as to isolate the internally-added crosslinked resin particles.

The obtained disk-shaped sample as the measurement sample is interposed between parallel plates having a diameter of 8 mm, and dynamic viscoelasticity is measured under the following conditions by raising the measurement temperature from 10° C. to 150° C. at 2° C./min at a strain of 0.1% to 100%. A loss tangent tan δ at each temperature is obtained from a loss elastic modulus curve obtained by the measurement. Next, a peak temperature of the loss tangent tan δ is defined as the glass transition temperature Tg(E) of the internally-added crosslinked resin particles.

### Measurement Conditions

Measurement device: rheometer ARES-G2 (manufactured by TA Instruments)
Gap: adjusted to 3 mm
Frequency: 1 Hz

In the internally-added crosslinked resin particles, in a case where a glass transition temperature obtained by Fox equation from a ratio (mass proportion) of constitutional monomers of a styrene-(meth)acrylic copolymer in the entire resin particles is defined as Tg1 and a glass transition temperature obtained by Fox equation from a ratio (mass proportion) of constitutional monomers of a styrene-(meth)acrylic copolymer, calculated from surface analysis of the resin particles, is defined as Tg2, for example, the following expression (T11) and the following expression (T21) are preferably satisfied, and the following expression (T12) and the following expression (T22) are more preferably satisfied. In this manner, the low-temperature fixability is improved.

$$5 ° C < Tg 2 - Tg 1 < 40 ° C \qquad Expression ( T11 )$$

$$10 ° C < Tg 2 - Tg 1 < 35 ° C \qquad Expression ( T12 )$$

$$100 ° C > Tg 2 > 0 ° C \qquad Expression ( T21 )$$

$$90 ° C > Tg 2 > 10 ° C \qquad Expression ( T22 )$$

Here, it is considered that the difference between the glass transition temperatures Tg1 and Tg2 according to the Fox equation means that the styrene-based monomer and the (meth)acrylic monomer do not bond randomly, and an arrangement in which a large amount of a component derived from styrene is localized on the particle surface and an arrangement in which a large amount of a component derived from the (meth)acrylic monomer is localized inside the particles are mixed. That is, it is considered that, since the glass transition temperature of the polystyrene resin is approximately 100° C., and the glass transition temperature of the (meth)acrylic resin is usually lower than the glass transition temperature of the polystyrene resin, for example, the glass transition temperature of ethyl polyacrylate is approximately −20° C., a region having a large number of styrene-based units is unevenly distributed on the surface of the internally-added crosslinked resin particles.

The ratio of constitutional monomers of a styrene-(meth)acrylate-based copolymer in the entire resin particles is quantified from NMR analysis.

The ratio of constitutional monomers of a styrene-(meth)acrylate-based copolymer, calculated from the surface analysis of the resin particles, is quantified by the following measurement.

The resin particles are dried, and surface composition analysis is performed with an X-ray photoelectron spectrometer (XPS). JPS-9000MX manufactured by JEOL Ltd. is used as the XPS measurement device, the measurement is performed using MgKa radiation as an X-ray source, at an acceleration voltage set to 10 kV, and an emission current set to 30 μmA. A ratio O(p) of the oxygen element to the sum of the carbon element and the oxygen element in the resin particles is obtained by the following equation.

$$O ( p ) = Number of oxygen elements / ( Number of carbon elements + Number of oxygen elements )$$

In addition, a resin made of only (meth)acrylate is produced, and a ratio O(a) of the oxygen element in the (meth)acrylate is obtained in the same manner.

From these measurement results, in a case where the sum of styrene and (meth)acrylate is set to 1, the surface (meth)acrylate ratio Wa(S) and the surface styrene ratio Ws(S) can be calculated by the following equations.

$$Wa ( S ) = O ( p ) / O ( a )$$

$$Ws ( S ) = 1 - ( O ( p ) / O ( a ) )$$

Next, the glass transition temperatures Tg1 and Tg2 are calculated from the respective ratio of the constitutional monomers obtained above by the Fox equation. Specifically, the glass transition temperatures are obtained as follows.

In a case where a glass transition temperature of a homopolymer of the (meth)acrylic monomer is denoted by TgA (K), a ratio (mass proportion; % by mass) of the (meth)acrylic monomer is denoted by WA, a glass transition temperature of a homopolymer of the styrene-based monomer is denoted by TgS (K), and a ratio (mass proportion; % by mass) of the styrene-based monomer is denoted by WS, a target glass transition temperature Tg0 (K) satisfies the following Fox equation.

$$Fox equation : 1 / Tg 0 = ( WA / TgA ) + ( WS / TgS )$$

By substituting the glass transition temperature and the ratio of each (meth)acrylic monomer and the glass transition temperature and the ratio of the styrene-based monomer in the entire resin particles or on the surface of the resin particles into the Fox equation, T0=“target glass transition temperature Tg1 or Tg2” is calculated by the Fox equation.

The glass transition temperature of the homopolymer of the (meth)acrylic monomer and the glass transition temperature of the homopolymer of the styrene-based monomer may be measured values or catalog values.

In the internally-added crosslinked resin particles including the styrene-(meth)acrylic copolymer, the adjustment of Tg(E), Tg1, Tg2, and the like can be achieved by adjusting polymerization conditions of the copolymer.

In particular, in order to obtain resin particles in which a composition gradient occurs in the internally-added crosslinked resin particles and a region having a large number of styrene-based units is unevenly distributed on the surface, in a case of producing the resin particles by polymerization of a monomer-containing solution containing a styrene-based monomer and a (meth)acrylic monomer, for example, it is preferable to increase a content ratio of the styrene-based monomer to the (meth)acrylic monomer in the monomer-containing solution as the polymerization proceeds. The “increasing as the polymerization proceeds” typically refers to gradually increasing the content ratio of the styrene-based monomer in the monomer-containing solution, but also includes operations such as gradually increasing the content of the styrene-based monomer in an added monomer in a case of additional adding the monomers to the monomer-containing solution a plurality of times, and increasing the amount of the added styrene-based monomer to gradually increase the concentration of the styrene-based monomer in the monomer-containing solution. For example, in a case of preparing the styrene-(meth)acrylic copolymer by an emulsion polymerization method, the content of the styrene-based monomer in the emulsion can be gradually increased in a case where the emulsion is added dropwise a plurality of times.

Furthermore, the progress of the reaction can be controlled by adjusting polymerization temperature, polymerization time, method of adding a polymerization initiator, and the like in combination.

A content of the internally-added crosslinked resin particles is, for example, preferably 2% by mass or more and 20% by mass or less, and more preferably 5% by mass or more and 15% by mass or less with respect to the entire toner.

In a case where the content of the internally-added crosslinked resin particles is within the above-described range, the growth of the domain of the crystalline polyester resin is easily suppressed. As a result, the transfer unevenness in a high-temperature and high-humidity environment is easily suppressed. In addition, the low-temperature fixability is improved.

Here, a ratio Ws/Wc of a content Ws of the internally-added crosslinked resin particles to a content We of the crystalline polyester resin with respect to the toner particles is, for example, preferably 0.13 or more and 1.50 or less, more preferably 0.25 or more and 1.25 or less, and still more preferably 0.30 or more and 1.00 or less in terms of mass ratio.

In a case where the ratio Ws/Wc is within the above-described range, the growth of the domain of the crystalline polyester resin is easily suppressed. As a result, the transfer unevenness in a high-temperature and high-humidity environment is easily suppressed.

The average dispersion size of the internally-added crosslinked resin particles is 100 nm or more and 300 nm or less, and for example, preferably 120 nm or more and 250 nm or less, and more preferably 150 nm or more and 230 nm or less.

In any case where the average dispersion size of the internally-added crosslinked resin particles is less than 100 nm or more than 300 nm, the internally-added crosslinked resin particles are excessively small or large, and the growth of the domain of the crystalline polyester resin is unlikely to be suppressed. As a result, the transfer unevenness in a high-temperature and high-humidity environment is less likely to be suppressed. In addition, the low-temperature fixability is deteriorated.

A method of measuring the average dispersion size of the internally-added crosslinked resin particles is as follows.

The toner particles or the toner is mixed with and embedded in an epoxy resin, and the epoxy resin is solidified. The obtained solidified substance is cut with an ultramicrotome device (UltracutUCT manufactured by Leica Microsystems), thereby producing a thin sample having a thickness of 80 nm or more and 130 nm or less. Next, the obtained thin sample is dyed with ruthenium tetroxide in a desiccator at 30° C. for 3 hours. By using an ultra-high resolution field emission scanning electron microscope (FE-SEM, S-4800 manufactured by Hitachi High-Tech Corporation.), an SEM image of dyed flake sample is obtained. Since ease of dyeing with ruthenium tetroxide varies in the order of the release agent, the styrene-(meth)acrylic resin, and the polyester resin, each component is identified by shade resulting from the degree of dyeing. In a case where it is difficult to distinguish the light and shade due to the condition of the sample or the like, the staining time is adjusted.

In the cross section of the toner particles, the domain of the colorant is smaller than the domain of the release agent and the domain of the resin particles, so that the domains are distinguished by the size.

In the SEM image, 30 toner cross sections having a maximum length of 85% or more of the volume-average particle size of the toner particles are selected, and a total of 100 dyed internally-added crosslinked resin particles (that is, domains thereof) are observed. The maximum length of each domain is measured, the maximum length is regarded as the diameter of the domain, and the diameter is arithmetically averaged to obtain an average equivalent circle diameter. The obtained average equivalent circle diameter is defined as the average dispersion size of the internally-added crosslinked resin particles.

Examples of the adjustment of the average dispersion size of the internally-added crosslinked resin particles include a method of producing the toner particles by aggregation and coalescence and adjusting the volume-average particle size of the internally-added crosslinked resin particles contained in the specific resin particle dispersion used in production; and a method of controlling the average equivalent circle diameter by preparing a plurality of internally-added crosslinked resin particle dispersions with different volume-average particle sizes and using the specific resin particle dispersions in combination.

An average shape factor SF-1 of the internally-added crosslinked resin particles is, for example, preferably 130 or less.

In a case where the average shape factor SF-1 of the internally-added crosslinked resin particles is within the above-described range, the growth of the domain of the crystalline polyester resin is easily suppressed. As a result, the transfer unevenness in a high-temperature and high-humidity environment is easily suppressed. In addition, the low-temperature fixability is improved.

The average shape factor SF-1 is obtained by the following equation.

$$S F - 1 = ( M L / A ) \times ( π / 4 ) \times 100$$

In the above equation, ML represents an absolute maximum length of the toner particles, and A represents a projected area of the toner particles.

Specifically, a sample is prepared in the same manner as in the measurement of the average dispersion size of the internally-added crosslinked resin particles described above. In the SEM image, 30 toner cross sections having a maximum length of 85% or more of the volume-average particle size of the toner particles are selected, and a total of 100 dyed internally-added crosslinked resin particles are observed. The observed SEM image is taken into an image analysis processing system Luzex (manufactured by NIRECO), the maximum length and the projected area of 100 particles are obtained, average shape factors are calculated from the above equation, and an average value thereof are obtained. The obtained average value is defined as the average shape factor SF-1 of the internally-added crosslinked resin particles.

In a case where a square region of 3 μm×3 μm having a size of 600 pix×600 pix in a cross-sectional observation of the toner particles is divided into n×n regions, in the n×n divided regions, from DAR(n) that is a coefficient of variation of an area ratio of the internally-added crosslinked resin particles to an area of the divided regions and slope F(16) that is a slope of an approximate straight line in a dispersion diagram obtained by changing the n to 3, 4, 6, 8, 12, and 16 and plotting log[1/n] on an X-axis and log[DAR(n)] on a Y-axis, the following expression (1) is satisfied, and for example, it is preferable to satisfy the following expression (11) and it is more preferable to satisfy the following expression (12).

$$0 \text{.6} \leq slope F ( 16 ) \qquad Expression ( 1 )$$

$$0.7 \leq slope F ( 16 ) \qquad Expression ( 11 )$$

$$0.8 \leq slope F ( 16 ) \qquad Expression ( 12 )$$

Here, the coefficient of variation DAR(n) of the area ratio of the internally-added crosslinked resin particles is a coefficient of variation calculated by an expression: DAR(n)=AR(n)sd/AR(n)ave.

AR(n)sd is a standard deviation of the area ratio of the internally-added crosslinked resin particles to the area of the divided regions in the n×n divided regions.

AR(n)ave is an arithmetic mean value of the area ratio of the internally-added crosslinked resin particles to the area of the divided regions in the n×n divided regions.

The coefficient of variation DAR(n) of the area ratio of the internally-added crosslinked resin particles is an index indicating dispersibility of the internally-added crosslinked resin particles; and in a case where the dispersibility is high, the variation in abundant amount of the internally-added crosslinked resin particles in the n×n divided regions is small, and in a case where the dispersibility is low, the variation in abundant amount of the internally-added crosslinked resin particles in the n×n divided regions is large.

On the other hand, in a case where the number of divisions (that is, the number n) of the divided regions is large, the number of regions in which the internally-added crosslinked resin particles are not present increases in the n×n divided regions, and the variation in abundant amount of the internally-added crosslinked resin particles increases, regardless of whether the dispersibility of the internally-added crosslinked resin particles is too high or too low.

That is, in a case where the number of divisions of the divided regions is changed, as the dispersibility of the internally-added crosslinked resin particles is higher, the change in the coefficient of variation DAR(n) of the area ratio of the internally-added crosslinked resin particles is greater.

Therefore, setting the value of slope F(16) to 0.6 or more represents that the dispersibility is good and the internally-added crosslinked resin particles are present inside the toner particles, and thus the growth of the domain of the crystalline polyester resin is suppressed. As a result, the transfer unevenness in a high-temperature and high-humidity environment is easily suppressed.

The standard deviation AR(n)sd of the area ratio of the internally-added crosslinked resin particles, the arithmetic mean value AR(n)ave of the area ratio of the internally-added crosslinked resin particles, the coefficient of variation DAR(n) of the area ratio of the internally-added crosslinked resin particles, and the slope F(16) are measured and calculated as follows.

The toner particles or the toner is mixed with and embedded in an epoxy resin, and the epoxy resin is solidified. The obtained solidified substance is cut with an ultramicrotome device (UltracutUCT manufactured by Leica Microsystems), thereby producing a thin sample having a thickness of 0.2 μm or more and 0.3 μm or less. Next, the obtained thin sample is dyed with ruthenium tetroxide in a desiccator at 30° C. for 3 hours. By using an ultra-high resolution field emission scanning electron microscope (FE-SEM, 5-4700 manufactured by Hitachi High-Tech Corporation.), an SEM image of dyed flake sample is obtained. Since ease of dyeing with ruthenium tetroxide varies in the order of the release agent, the styrene-(meth)acrylic resin, and the polyester resin, each component is identified by shade resulting from the degree of dyeing. In a case where it is difficult to distinguish the light and shade due to the condition of the sample or the like, the staining time is adjusted.

In the cross section of the toner particles, the domain of the colorant is smaller than the domain of the release agent and the domain of the resin particles, so that the domains are distinguished by the size.

In the SEM image, a cross section of the toner particles, in which the maximum length is 85% or more of the volume-average particle size of the toner particles, is selected.

A square region of 3 μm×3 μm having a size of 600 pix×600 pix is cut out from the cross section of the toner particles in the SEM image, and a fractal dimension of the square region in the cross section of the toner particles is calculated by image processing software (Image J; manufactured by National Institutes of Health).

The procedure for measuring the fractal dimension using the image processing software (Image J; manufactured by National Institutes of Health) is as follows.
1. In Analyze →Set Scale, defining a relationship between the number of pixels on the image and the actual distance (Distance in Pixels: 600, Known distance: 3, Pixel Aspect: 1, Unit of length: um) are input, check box, Global is checked
2. Selecting Image→Type→8-bit
3. Selecting Process→Filters→Median . . . , inputting Radius: 2.0 pixels, and pressing OK
4. Selecting Image→Adjust→Threshold, checking Dark background, clicking Auto button, and then clicking Apply button
5. The image noise is removed by processing of Process→Noise →Despeckle.
6. Selecting Process→Filters →Median . . . , inputting Radius: 10.0 pixels, and pressing OK

By the above-described operation, a binarized image of the internally-added crosslinked resin particles in the square region is obtained.

Next, the square region is divided into 3 (n=3) parts, and the area ratio of the internally-added crosslinked resin particles to each of the divided regions is obtained in a total of 6 divided regions.

From the area ratios of the internally-added crosslinked resin particles of the 6 divided regions obtained, the standard deviation AR(n=3)sd of the area ratio of the internally-added crosslinked resin particles, the arithmetic mean value AR(n=3)ave of the area ratio of the internally-added crosslinked resin particles, and the coefficient of variation DAR(n=3) of the area ratio of the internally-added crosslinked resin particles are obtained.

The standard deviation AR(n)sd of the area ratio of the internally-added crosslinked resin particles is calculated by obtaining a difference between the arithmetic mean value AR(n)ave of the area ratio of the internally-added crosslinked resin particles and the area ratio of the internally-added crosslinked resin particles in each divided region, squaring the obtained difference, and calculating the total value of the squared values and multiplying the total value by (½).

Next, similarly, the number of divisions of the square region is set to 4, 6, 12, and 16 (that is, n=4, 6, 12, and 16), and the area ratios of the internally-added crosslinked resin particles of the obtained respective divided regions are obtained, and from the area ratios of the internally-added crosslinked resin particles of the obtained respective divided regions, the standard deviation AR(n=4, 6, 12, and 16)sd of the area ratio of the internally-added crosslinked resin particles, the arithmetic mean value AR(n=4, 6, 12, and 16)ave of the area ratio of the internally-added crosslinked resin particles, and the coefficient of variation DAR(n=4, 6, 12, and 16) of the area ratio of the internally-added crosslinked resin particles are obtained.

Next, a dispersion diagram in which log[1/n] is plotted on an X-axis and log[DAR(n)] is plotted on a Y-axis in a case where the number n of divisions is 3, 4, 6, 8, 12, and 16 is obtained, and a slope of an approximate straight line in the scatter diagram is obtained as the slope F(16). The slope of the approximate straight line is obtained by a least squares method.

The above-described operation is performed on 200 toner particles, and an average value of the slopes is calculated as the slope F(16).

In the cross-sectional observation of the toner particles, the area ratio of the internally-added crosslinked resin particles to a cross section of the toner particles is, for example, preferably more than 15% and 48% or less, more preferably more than 16% and 40% or less, and still more preferably more than 18% and 35% or less.

In a case where the area ratio of the internally-added crosslinked resin particles is within the above-described range, the growth of the domain of the crystalline polyester resin is easily suppressed. As a result, the transfer unevenness in a high-temperature and high-humidity environment is easily suppressed. In addition, the low-temperature fixability is improved.

A method for measuring the area ratio of the internally-added crosslinked resin particles is as follows.

In the same manner as in the calculation of “slope F(16)” described above, an SEM image of the cross section of the toner particles is obtained, and from the image, the area ratio of the internally-added crosslinked resin particles to the cross section of the toner particles is obtained.

Next, the above-described operation is performed on 200 toner particles, and an average value of the area ratios of the internally-added crosslinked resin particles is calculated.

### Method for Producing Internally-added Crosslinked Resin Particles

As a method for producing the internally-added crosslinked resin particles, for example, a known method such as an emulsion polymerization method, a melt-kneading method using a Banbury mixer or a kneader, a suspension polymerization method, and a spray drying method is adopted. For example, an emulsion polymerization method is preferable in order to unevenly distribute the units derived from the styrene-based monomer on the surface of the particles.

In the method for producing the internally-added crosslinked resin particles, for example, it is preferable to use a styrene-based monomer and a (meth)acrylic monomer as monomers and to carry out polymerization in the presence of a crosslinking agent.

In the method for producing the internally-added crosslinked resin particles, for example, it is preferable to perform emulsion polymerization a plurality of times.

Hereinafter, the method for producing the internally-added crosslinked resin particles will be described in more detail.

For example, it is preferable that the method for producing the internally-added crosslinked resin particles includes a step (emulsion preparation step) of obtaining an emulsion containing a monomer, a crosslinking agent, a surfactant, and water; a step (first emulsion polymerization step) of adding a polymerization initiator to the emulsion and then heating to polymerize the monomer; and a step (second emulsion polymerization step) of adding an emulsion containing a monomer and a crosslinking agent to the reaction solution after the first emulsion polymerization step, and then heating to polymerize the monomers.

Furthermore, in the second emulsion polymerization step, in order to adjust the composition of the surface of the particles, after preparing the emulsion by changing the ratio of the styrene-based monomer and the (meth)acrylic monomer, the emulsion may be added a plurality of times.

### Emulsion Preparation Step

The emulsion preparation step is a step of obtaining an emulsion containing a monomer, a crosslinking agent, a surfactant, and water.

For example, it is preferable to obtain the emulsion by emulsifying a monomer, a crosslinking agent, a surfactant, and water by using an emulsifying machine.

Examples of the emulsifying machine include a rotary stirrer equipped with a propeller type, anchor type, paddle type, or turbine type stirring blade; a stationary mixer such as a static mixer; a rotor and stator type emulsifying machine such as a homogenizer and Clare mix; a mill type emulsifying machine having grinding function; a high-pressure emulsifying machine such as a Manton-Gaulin-type pressure emulsifying machine; a high-pressure nozzle type emulsifying machine that causes cavitation under high pressure; a high-pressure impact-type emulsifying machine, such as a microfluidizer, that generates shearing force by causing collision of liquids under high pressure; an ultrasonic emulsifying machine that causes cavitation by using ultrasonic waves; and a membrane emulsifying machine that performs emulsification through pores.

As the monomers, for example, it is preferable to use a styrene-based monomer and a (meth)acrylic monomer.

As the crosslinking agent, the aforementioned crosslinking agent is used.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. The nonionic surfactant may be used in combination with an anionic surfactant or a cationic surfactant. Among these surfactants, for example, an anionic surfactant is preferable. One kind of surfactant may be used alone, or two or more kinds of surfactants may be used in combination.

The emulsion may contain a chain transfer agent. The chain transfer agent is not particularly limited. As the chain transfer agent, a compound having a thiol component can be used. Specifically, for example, alkyl mercaptans such as hexyl mercaptan, heptyl mercaptan, octyl mercaptan, nonyl mercaptan, decyl mercaptan, and dodecyl mercaptan are preferable.

A mass ratio of the styrene-based monomer to the (meth)acrylic monomer in the emulsion (styrene-based monomer/(meth)acrylic monomer) is, for example, preferably 0.2 or more and 1.1 or less.

In addition, the content of the crosslinking agent with respect to the entire emulsion is, for example, preferably 0.5% by mass or more and 3% by mass or less.

### First Emulsion Polymerization Step

The first emulsion polymerization step is a step of adding a polymerization initiator to the emulsion and heating the emulsion so as to polymerize the monomers.

Here, in the polymerization, for example, it is preferable to stir the emulsion (reaction solution) containing the polymerization initiator with a stirrer.

Examples of the stirrer include a rotary stirrer equipped with a propeller type, anchor type, paddle type, or turbine type stirring blade.

As the polymerization initiator, for example, it is preferable to use ammonium persulfate.

### Second Emulsion Polymerization Step

The second emulsion polymerization step is a step of adding an emulsion containing a monomer to the reaction solution obtained after the first emulsion polymerization step, and heating to polymerize the monomer.

In the polymerization, for example, it is preferable to stir the reaction solution in the same manner as in the first emulsion polymerization step.

In the present step, the ratio of the styrene-based monomer and the (meth)acrylic monomer in the emulsion containing the monomers may be changed, and the emulsion may be added by dividing the emulsion into a plurality of times.

For example, it is preferable to obtain the emulsion containing monomers by emulsifying monomers, a surfactant, and water by using an emulsifying machine.

### Other Additives

Examples of other additives include well-known additives such as a magnetic material, a charge control agent, and inorganic powder. The additives are incorporated into the toner particles as internal additives.

### Characteristics of Toner Particles and the Like

The toner particles may be toner particles that have a single-layer structure or toner particles having a so-called core/shell structure that is configured with a core portion (core particle) and a coating layer (shell layer) coating the core portion.

The toner particles having a core/shell structure may, for example, be configured with a core portion that is configured with the binder resin, the internally-added crosslinked resin particles, and other additives used as necessary, such as a colorant and a release agent, and a coating layer that is configured with the binder resin and the internally-added crosslinked resin particles.

The volume-average particle size (D50v) of the toner particles is, for example, preferably 2 μm or more and 10 μm or less, and more preferably 4 μm or more and 8 μm or less.

The various average particle sizes and various particle size distribution indexes of the toner particles are measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MIULTISIZER II with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-average particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-average particle size D84v and a number-based particle size D84p.

By using these, a volume particle size distribution index (GSDv) is calculated as (D84v/D16v)^{1/2} and a number particle size distribution index (GSDp) is calculated as (D84p/D16p)^{1/2}.

The average circularity of the toner particles is, for example, preferably 0.90 or more and 1.00 or less, and more preferably 0.92 or more and 0.98 or less.

The average circularity of the toner particles is determined by (Equivalent circular perimeter)/(Perimeter) [(Perimeter of circle having the same projected area as particle image)/(Perimeter of projected particle image)]. Specifically, the average circularity is a value measured by the following method.

First, toner particles as a measurement target are collected by suction, and a flat flow of the particles is formed. Thereafter, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains the external additive, the toner (developer) as a measurement target is dispersed in water containing a surfactant, then the dispersion is treated with ultrasonic waves such that the external additive is removed, and the toner particles are collected.

### External Additive

Examples of the external additive include inorganic particles. Examples of the inorganic particles include particles such as SiO₂, TiO₂, Al₂O₃, SrTiO₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobization treatment. The hydrophobization treatment is performed, for example, by dipping the inorganic particles in a hydrophobizing agent. The hydrophobizing agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 10% by mass or less, and more preferably 0.01% by mass or more and 6.0% by mass or less.

### Dielectric Loss Factor of Toner

In the toner according to the present exemplary embodiment, a dielectric loss factor of the toner after being left to stand at a temperature of 28° C. and a relative humidity of 85% RH at 1 kHz is, for example, preferably 35×10⁻³ or less, more preferably 30×10⁻³ or less, and still more preferably 25×10⁻³ or less.

In a case where the dielectric loss factor of the toner according to the present exemplary embodiment is within the above-described range, many domains of the crystalline polyester resin do not excessively grow, and a state in which the conduction path is not formed inside the toner particles is obtained. Therefore, even in a case where the moisture content of the toner particles increases in a high-temperature and high-humidity environment, the charge injection properties are unlikely to deteriorate. As a result, the transfer unevenness in a high-temperature and high-humidity environment is easily suppressed.

The dielectric loss factor of the toner can be adjusted by controlling the content of the crystalline polyester and the internally-added crosslinked resin particles, controlling the dispersion state of the internally-added crosslinked resin particles inside the toner particles, controlling the glass transition temperature Tg(E) of the internally-added crosslinked resin particles, controlling the amount of trace impurities (Na and the like) present in the toner particles, and the like.

Here, the dielectric loss factor of the toner will be described. First, a dielectric loss tangent (tan δ) is represented by a ratio of a real part ε′ to an imaginary part ε″ in a complex dielectric constant ε=ε′−iε″ (i is an imaginary unit), and the dielectric loss factor (tan δ) is represented by ε″/ε′. Among these, the imaginary part ε″ is referred to as a dielectric loss ratio.

A method for measuring the dielectric loss factor of the toner is as follows.

6 g of the toner to be measured is weighed, left in an environment of a temperature of 28° C. and a relative humidity of 85% RH for 3 hours or longer, and then molded into a pellet shape with a load of 10 tons for 1 minute. The obtained pellet is left in an environment of a temperature of 28° C. and a relative humidity of 85% RH for 1 hour or longer, and then set between electrodes having a diameter of 3.8 cm, and the dielectric loss factor of the toner is measured in an environment of 28° C. and 85% RH under conditions of a frequency of 1 kHz and a voltage of 5 V using an LCR meter (LCR meter 6440A type; manufactured by TOYO Corporation).

### Manufacturing Method of Toner

Next, the manufacturing method of the toner according to the present exemplary embodiment will be described.

The toner according to the present exemplary embodiment is obtained by manufacturing toner particles and then externally adding external additives to the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). The manufacturing method of the toner particles is not particularly limited to these manufacturing methods, and a well-known manufacturing method is adopted.

Among the above methods, for example, the aggregation and coalescence method may be used for obtaining toner particles.

Specifically, in a case where the toner particles are manufactured by an aggregation and coalescence method, for example, the toner particles are manufactured through a step (first aggregated particle-forming step) of forming first aggregated particles by mixing a first amorphous resin particle dispersion in which first amorphous resin particles as a binder resin are dispersed, a crystalline resin particle dispersion in which crystalline resin particles as a binder resin are dispersed, an internally-added crosslinked resin particle dispersion in which internally-added crosslinked resin particles are dispersed, a colorant dispersion in which a colorant is dispersed, and a release agent particle dispersion in which particles of a release agent (hereinafter, also referred to as “release agent particles”) are dispersed, and aggregating the particles and the colorant in the obtained dispersion; a step (second aggregated particle-forming step) of forming second aggregated particles by, after obtaining the first aggregated particle dispersion in which the first aggregated particles are dispersed, adding second amorphous resin particles as a binder resin to the first aggregated particle dispersion, and aggregating the second amorphous resin particles on a surface of the first aggregated particles; and a step (coalescence step) of heating the second aggregated particle dispersion in which the second aggregated particles are dispersed to allow the second aggregated particles to undergo coalescence and to form toner particles.

Here, as the first amorphous resin particles and the second amorphous resin particles, amorphous polyester resin particles are applied; as the crystalline resin particles, crystalline polyester resin particles are applied; and as the internally-added crosslinked resin particles, styrene-(meth)acrylic copolymer particles are applied.

The present aggregation and coalescence method will be described as a method for producing toner particles containing a binder resin, a colorant, and a release agent; but the colorant and the release agent are components to be contained in the toner particles as necessary.

Hereinafter, each of the steps will be specifically described.

### Each Dispersion Preparing Step

First, each dispersion to be used in the aggregation and coalescence method is prepared. Specifically, the first amorphous resin particle dispersion in which a first amorphous resin as a binder resin is dispersed, a crystalline resin particle dispersion in which crystalline resin particles are dispersed, an internally-added crosslinked resin particle dispersion in which internally-added crosslinked resin particles are dispersed, a colorant dispersion in which a colorant is dispersed, a second amorphous resin particle dispersion in which second amorphous resin particles as a binder resin are dispersed, and a release agent particle dispersion in which release agent particles are dispersed are prepared.

In each dispersion preparing step, the first amorphous resin particles, the second amorphous resin particles, and the crystalline resin particles will be referred to as “resin particles” in the following description.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase inversion) from W/O to O/W, turns into a discontinuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 m or more and 0.8 μm or less, and still more preferably 0.1 μm or more and 0.6 μm or less.

For determining the volume-average particle size of the resin particles, a particle size distribution is measured using a laser diffraction type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, the colorant dispersion, the release agent particle dispersion, and the internally-added crosslinked resin particle dispersion are also prepared in the same manner as the resin particle dispersion. That is, the volume-average particle size of the particles, the dispersion medium, the dispersion method, and the content of the particles in the resin particle dispersion are also applied to the colorant to be dispersed in the colorant dispersion, the release agent particles to be dispersed in the release agent particle dispersion, and the internally-added crosslinked resin particles to be dispersed in the internally-added crosslinked resin particle dispersion.

### First Aggregated Particle-Forming Step

Next, the first amorphous resin particle dispersion, the crystalline resin particle dispersion, the internally-added crosslinked resin particle dispersion, the colorant dispersion, and the release agent particle dispersion are mixed with each other.

Then, in the mixed dispersion, the first amorphous resin, the crystalline resin particles, the internally-added crosslinked resin particles, the colorant, and the release agent particles are hetero-aggregated to form first aggregated particles containing the first amorphous resin, the internally-added crosslinked resin particles, the colorant, and the release agent particles.

Specifically, for example, an aggregating agent is added to a dispersion obtained by mixing the first amorphous resin particle dispersion, the crystalline resin particle dispersion, the internally-added crosslinked resin particle dispersion, the colorant dispersion, and the release agent particle dispersion; the pH of the mixed dispersion is adjusted to acidic (for example, pH of 2 or more and 5 or less); a dispersion stabilizer is added thereto as necessary; the temperature is set to a temperature region of 20° C. or higher and 50° C. or lower; and the particles dispersed in the mixed dispersion are aggregated to form the first aggregated particles.

In the first aggregated particle-forming step, for example, in a state where the mixed dispersion is stirred with a rotary shearing homogenizer, the aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. In particular, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added is, for example, preferably 0.01 parts by mass or more and 5.0 parts by mass or less, and more preferably 0.1 parts by mass or more and less than 3.0 parts by mass with respect to 100 parts by mass of the resin particles (the first resin particles, the crystalline resin particles, and the internally-added crosslinked resin particles).

### Second Aggregated Particle-Forming Step

Next, after obtaining the first aggregated particle dispersion in which the first aggregated particles are dispersed, a second amorphous resin particle dispersion in which the second amorphous resin particles are dispersed is added to the first aggregated particle dispersion.

The second amorphous resin particles may be the same as or different from the first amorphous resin.

Next, the second amorphous resin particles are aggregated on the surface of the first aggregated particles in the dispersion of the first aggregated particles and the second amorphous resin particles. In this case, by further adding the release agent particle dispersion, the second amorphous resin particles and the release agent particles may be aggregated on the surface of the first aggregated particles. Specifically, for example, in the first aggregated particle-forming step, in a case where the first aggregated particles reach a target particle size, the second amorphous resin particle dispersion is added to the first aggregated particle dispersion, and the mixture is heated at a temperature equal to or lower than the glass transition temperature of the second amorphous resin particles.

By setting the pH of the dispersion in a range of, for example, about 6.5 or more and 8.5 or less, the progress of aggregation is stopped.

In this way, the second aggregated particles are obtained in which the second amorphous resin particles are aggregated so as to adhere to the surface of the first aggregated particles.

### Coalescence Step

Next, the second aggregated particle dispersion in which the second aggregated particles are dispersed is heated to, for example, a temperature equal to or higher than the glass transition temperatures of the first and second amorphous resin particles (for example, a temperature higher than the glass transition temperatures of the first and second amorphous resin particles by 10° C. to 30° C.) such that the second aggregated particles coalesce, thereby forming toner particles.

The toner particles are obtained through the above steps.

In the aggregation and coalescence method described above, the first aggregated particles may be coalesced to form the toner particles without performing the second aggregated particle-forming step. In addition, the second aggregated particle-forming step may be repeated a plurality of times.

In addition, in the second aggregated particle-forming step, a crystalline resin particle dispersion may be used, or an internally-added crosslinked resin particle dispersion may be used.

Here, in the manufacturing method of the toner according to the above-described aggregation and coalescence method, in order to obtain toner particles satisfying the above expression (1), for example, the above-described first aggregated particle-forming step may be performed as follows.

First, as the first amorphous resin particle dispersion, a small-diameter amorphous resin particle dispersion in which small-diameter amorphous resin particles are dispersed and a large-diameter amorphous resin particle dispersion in which large-diameter amorphous resin particles are dispersed are prepared.

A volume-average particle size of the small-diameter amorphous resin particles is, for example, 60 nm or more and 130 nm or less. On the other hand, a volume-average particle size of the large-diameter amorphous resin particles is, for example, 150 nm or more and 200 nm or less. The method of measuring the volume-average particle size is the same as the method using the laser diffraction type particle size distribution analyzer described above.

Next, a pH of the small-diameter amorphous resin particle dispersion is adjusted to be in a range of 2 to 5, and a pH of the internally-added crosslinked resin particle dispersion is adjusted to be in a range of ±0.5 of the pH of the small-diameter amorphous resin particle dispersion after the adjustment.

Next, the internally-added crosslinked resin particle dispersion is added dropwise to the small-diameter amorphous resin particle dispersion while stirring the mixture to obtain a mixed dispersion A1. An aggregating agent is added to the mixed dispersion A1 to obtain a mixed dispersion A2, and the mixed dispersion A2 is held at 30° C. for a certain period of time while stirring.

On the other hand, the large-diameter amorphous resin particle dispersion, the crystalline resin particle dispersion, the colorant dispersion, and the release agent particle dispersion are mixed to obtain a mixed dispersion B1, and a pH of the mixed dispersion B1 is adjusted to be in a range of 0.5 of the pH of the mixed dispersion A2.

Next, the mixed dispersion B2 is added dropwise to the mixed dispersion A2 while stirring the mixture to obtain a mixed dispersion C1. The mixed dispersion C1 after the dropwise addition is heated to be raised in temperature, and aggregates of the small-diameter amorphous resin particles and the internally-added crosslinked resin particles are aggregated with the large-diameter amorphous resin particles, the crystalline resin particles, the colorant, and the release agent particles, thereby obtaining a mixed dispersion C2.

Next, a second aggregation step is performed using the mixed dispersion C2.

In a case where each dispersion is added dropwise, for example, it is preferable to set a stirring speed (that is, a stirring blade tip speed) to a low speed to reduce aggregation between unstable particles during the mixing of each dispersion.

For example, it is preferable to reduce an input rate of the aggregating agent to suppress the local increase in concentration of the aggregating agent and to reduce the aggregation between unstable particles.

During the aggregation, for example, it is preferable to reduce the concentration of solid contents of each mixed dispersion to reduce collision frequency between particles and to reduce the aggregation of unstable particles.

By performing the first aggregation step as described above, it is possible to obtain the toner particles satisfying the above expression (1).

After the coalescence step, the toner particles formed in a solution undergo a known washing step, solid-liquid separation step, and drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

For example, by adding an external additive to the obtained dry toner particles and mixing the external additive and the toner particles together, the toner according to the present exemplary embodiment is manufactured. The mixing may be performed, for example, using a V blender, a Henschel mixer, a Lodige mixer, or the like. Furthermore, coarse particles of the toner may be removed as necessary by using a vibratory sieving machine, a pneumatic sieving machine, or the like.

### Electrostatic Charge Image Developer

The electrostatic charge image developer according to the present exemplary embodiment contains at least the toner according to the present exemplary embodiment.

The electrostatic charge image developer according to the present exemplary embodiment may be a one-component developer that contains only the toner according to the present exemplary embodiment or a two-component developer that is obtained by mixing the toner and a carrier together.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating a core material, that are particles configuring the carrier, with a coating resin.

Examples of the magnetic powder include magnetic metals such as iron, nickel, and cobalt; and magnetic oxides such as ferrite and magnetite.

Examples of the coating resin and the matrix resin include a styrene (meth)acrylic acid resin; polyolefin-based resins such as a polyethylene resin and a polypropylene resin; polyvinyl-based or polyvinylidene-based resins such as polystyrene, a (meth)acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride vinyl acetate copolymer; a straight silicone resin consisting of an organosiloxane bond or a modified product thereof, a fluororesin such as polytetrafluoroethylene, polyvinyl fluoride, polyvinylidene fluoride, or polychlorotrifluoroethylene; polyester; polyurethane; polycarbonate; an amino resin such as a urea formaldehyde resin; and an epoxy resin.

For example, the coating resin and the matrix resin preferably contain a (meth)acrylic resin, more preferably contain 50% by mass or more of the (meth)acrylic resin with respect to the total mass of the resin, and still more preferably contain 80% by mass or more of the (meth)acrylic resin with respect to the total mass of the resin.

In particular, for example, the coating resin and the matrix resin preferably contain an alicyclic (meth)acrylic resin as the (meth)acrylic resin.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, that are used as necessary, in an appropriate solvent, and the like. The solvent is not particularly limited, and may be selected in consideration of the type of the coating resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and removing solvents.

The mixing ratio (mass ratio) between the toner and the carrier, represented by toner:carrier, in the two-component developer is, for example, preferably 1:100 to 30:100, and more preferably 3:100 to 20:100.

### Image Forming Apparatus and Image Forming Method

The image forming apparatus and image forming method according to the present exemplary embodiment will be described.

The image forming apparatus according to the present exemplary embodiment includes an image holder, a charging device that charges the surface of the image holder, an electrostatic charge image forming device that forms an electrostatic charge image on the charged surface of the image holder, a developing device that contains an electrostatic charge image developer and develops the electrostatic charge image formed on the surface of the image holder as a toner image by using the electrostatic charge image developer, a transfer device that transfers the toner image formed on the surface of the image holder to the surface of a recording medium, and a fixing device that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed that has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning device that cleans the surface of the image holder before charging after the transfer of the toner image; and an apparatus including a charge neutralization device that neutralizes charge by irradiating the surface of the image holder with charge neutralizing light before charging after the transfer of the toner image.

In the case of the intermediate transfer-type apparatus, as the transfer device, for example, a configuration is adopted that has an intermediate transfer member with surface on which the toner image will be transferred, a primary transfer device that performs primary transfer to transfer the toner image formed on the surface of the image holder to the surface of the intermediate transfer member, and a secondary transfer device that performs secondary transfer to transfer the toner image transferred to the surface of the intermediate transfer member to the surface of a recording medium.

In the image forming apparatus according to the present exemplary embodiment, for example, a portion including the developing device may be a cartridge structure (process cartridge) to detachable from the image forming apparatus. As the process cartridge, for example, a process cartridge is suitably used that includes a developing device that contains the electrostatic charge image developer according to the present exemplary embodiment.

An example of the image forming apparatus according to the present exemplary embodiment will be shown below, but the present invention is not limited thereto. Hereinafter, among the parts shown in the drawing, main parts will be described, and others will not be described.

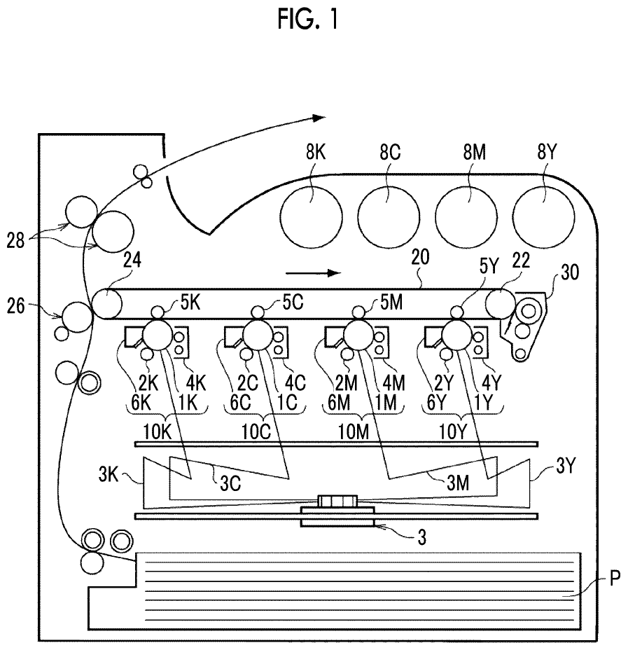

FIG. 1 is a view schematically showing the configuration of the image forming apparatus according to the present exemplary embodiment.

The image forming apparatus shown in FIG. 1 includes first to fourth image forming units 10Y, 10M, 10C, and 10K adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detached from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 that in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the outer peripheral surface of the intermediate transfer belt 20.

In addition, a toner including toners having four colors of yellow, magenta, cyan, and black, that are contained in containers of toner cartridges 8Y, 8M, 8C, and 8K, is supplied to developing devices (example of the developing device) 4Y, 4M, 4C, and 4K of the units 10Y, 10M, 10C, and 10K, respectively.

The first to fourth units 10Y, 10M, 10C, and 10K have the same configuration. Therefore, in the present specification, as a representative, the first unit 10Y will be described that placed on the upstream side of the running direction of the intermediate transfer belt and forms a yellow image. Reference numerals marked with magenta (M), cyan (C), and black (K) instead of yellow (Y) are assigned in the same portions as in the first unit 10Y, such that the second to fourth units 10M, 10C, and 10K will not be described again.

The first unit 10Y has a photoreceptor bY that acts as an image holder. Around the photoreceptor 1Y, a charging roll (an example of the charging device) 2Y that charges the surface of the photoreceptor 1Y at a predetermined potential, an exposure device (an example of the electrostatic charge image forming device) 3 that exposes the charged surface to a laser beam 3Y based on color-separated image signals to form an electrostatic charge image, a developing device (an example of the developing device) 4Y that develops the electrostatic charge image by supplying a charged toner to the electrostatic charge image, a primary transfer roll (an example of the primary transfer device) 5Y that transfers the developed toner image onto the intermediate transfer belt 20, and a photoreceptor cleaning device (an example of the cleaning device) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y As a result, an electrostatic charge image of a yellow image pattern is formed on the surface of the photoreceptor 1Y

The electrostatic charge image is an image formed on the surface of the photoreceptor 1Y by charging. The image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y turns into a visible image (developed image) as a toner image by the developing device 4Y

The developing device 4Y contains, for example, an electrostatic charge image developer that contains at least a yellow toner and a carrier. By being stirred in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 μA under the control of the control unit (not shown in the drawing).

On the other hand, the residual toner on the photoreceptor 1Y is removed by a photoreceptor cleaning device 6Y and collected.

In addition, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll (an example of the secondary transfer device) 26 disposed on the outer peripheral surface side of the intermediate transfer belt 20. On the other hand, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting device (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of the fixing device), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

### Process Cartridge and Toner Cartridge

The process cartridge according to the present exemplary embodiment will be described.

The process cartridge according to the present exemplary embodiment includes a developing device that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other devices, such as an image holder, a charging device, an electrostatic charge image forming device, and a transfer device, as necessary.

An example of the process cartridge according to the present exemplary embodiment will be shown below, but the present invention is not limited thereto. Hereinafter, among the parts shown in the drawing, main parts will be described, and others will not be described.

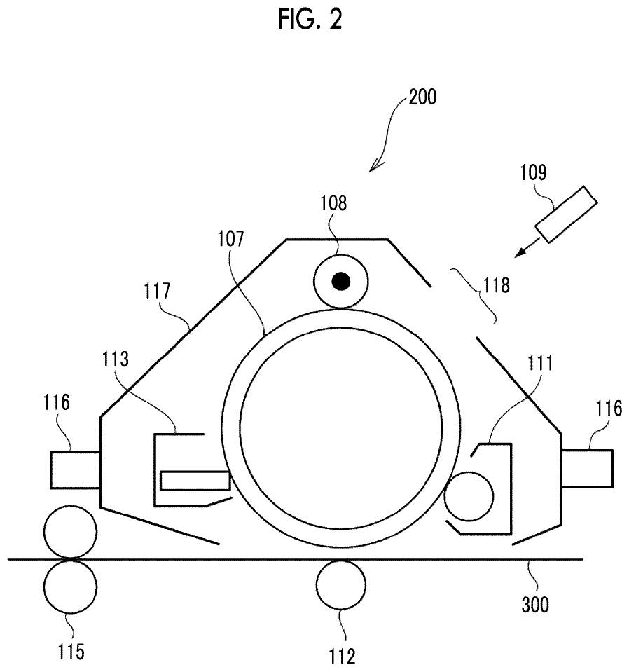

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging device) that is provided on the periphery of the photoreceptor 107, a developing device 111 (an example of developing device), a photoreceptor cleaning device 113 (an example of cleaning device), that are integrally combined and held in the housing 117. The process cartridge 200 forms a cartridge in this way.

In FIG. 2, 109 represents an exposure device (an example of electrostatic charge image forming device), 112 represents a transfer device (an example of transfer device), 115 represents a fixing device (an example of fixing device), and 300 represents recording paper (an example of recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing device provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In addition, in a case where the amount of the toner contained in the container of the toner cartridge is low, the toner cartridge is replaced.

### EXAMPLES

Examples will be described below, but the present invention is not limited to these examples. In the following description, unless otherwise specified, “parts” and “%” are based on mass.

### Preparation of Emulsions (1-1) to (1-4)

### Emulsion (1-1)

Styrene: 40 parts
n-Butyl acrylate: 58.5 parts
1,10-Decanediol diacrylate: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (1-1).

### Emulsion (1-2)

Styrene: 45 parts
n-Butyl acrylate: 53.5 parts
1,10-Decanediol diacrylate: 1.5 parts
Anionic surfactant (ELEMINOL MON-2): 1.2 parts
Deionized water: 98.8 parts

The above-described materials are charged into a mixing vessel equipped with a stirrer, and stirred to prepare an emulsion (1-2).

### Emulsion (1-3)

Styrene: 55 parts
n-Butyl acrylate: 43.5 parts
1,10-Decanediol diacrylate: 1.5 parts
Anionic surfactant (ELEMINOL MON-2): 1.2 parts
Deionized water: 98.8 parts

The above-described materials are charged into a mixing vessel equipped with a stirrer, and stirred to prepare an emulsion (1-3).

### Emulsion (1-4)

Styrene: 60 parts
n-Butyl acrylate: 38.5 parts
1,10-Decanediol diacrylate: 1.5 parts
Anionic surfactant (ELEMINOL MON-2): 1.2 parts
Deionized water: 98.8 parts

The above-described materials are charged into a mixing vessel equipped with a stirrer, and stirred to prepare an emulsion (1-4).

### Preparation of Internally-added Crosslinked Resin Particle Dispersion (1)

1.1 parts of an anionic surfactant (ELEMINOL MON-2) and 400 parts of deionized water are charged into a reaction vessel equipped with a stirrer and a nitrogen introduction tube, after replacing the inside of the reaction vessel with nitrogen. The reaction solution is heated in an oil bath while being stirred so that the temperature of the reaction solution is set to 75° C. After adding 10 parts of the emulsion (1-1) thereto, 20 parts of an ammonium persulfate aqueous solution in which a concentration is adjusted to 10% by mass is further added thereto, and the reaction solution is retained for 30 minutes.

Thereafter, in a state where the temperature of the reaction solution is maintained at 75° C., 190 parts of the emulsion (1-1) is gradually added dropwise to the reaction vessel over 30 minutes by a pump. 200 parts of the emulsion (1-2) is further added dropwise thereto over 30 minutes. Subsequently, 200 parts of the emulsion (1-3) is added dropwise thereto over 40 minutes, and then 200 parts of the emulsion (1-4) is added dropwise thereto over 40 minutes.

After completion of the dropwise addition, the solution is retained for 60 minutes, 2 parts of ammonium persulfate having a concentration of 10% by mass is added thereto, and the mixture is retained for another 3 hours and then cooled to room temperature. Thereafter, deionized water and nitric acid are added thereto so that the concentration of solid contents is 20% by mass, thereby obtaining an internally-added crosslinked resin particle dispersion (1).

A volume-average particle size of the obtained resin particles is 165 nm. In addition, a glass transition temperature measured with a differential scanning calorimeter is 17° C.

### Preparation of Emulsions (2-1) to (2-4)

### Emulsion (2-1)

Styrene: 40 parts
n-Butyl acrylate: 59.7 parts
1,10-Decanediol diacrylate: 0.32 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (2-1).

### Emulsion (2-2)

Styrene: 45 parts
n-Butyl acrylate: 54.7 parts
1,10-Decanediol diacrylate: 0.32 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (2-2).

### Emulsion (2-3)

Styrene: 55 parts
n-Butyl acrylate: 44.7 parts
1,10-Decanediol diacrylate: 0.32 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (2-3).

### Emulsion (2-4)

Styrene: 60 parts
n-Butyl acrylate: 39.7 parts
1,10-Decanediol diacrylate: 0.32 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (2-4).

### Preparation of Internally-Added Crosslinked Resin Particle Dispersion (2)

1.1 parts of an anionic surfactant (ELEMINOL MON-2) and 400 parts of deionized water are charged into a reaction vessel equipped with a stirrer and a nitrogen introduction tube, after replacing the inside of the reaction vessel with nitrogen. The reaction solution is heated in an oil bath while being stirred so that the temperature of the reaction solution is set to 75° C. After adding 10 parts of the emulsion (2-1) thereto, 60 parts of an ammonium persulfate aqueous solution in which a concentration is adjusted to 10% by mass is further added thereto, and the reaction solution is retained for 30 minutes.

Thereafter, in a state where the temperature of the reaction solution is maintained at 75° C., 190 parts of the emulsion (2-1) is gradually added dropwise to the reaction vessel over 30 minutes by a pump. 200 parts of the emulsion (2-2) is further added dropwise thereto over 30 minutes. Subsequently, 200 parts of the emulsion (2-3) is added dropwise thereto over 40 minutes, and then 200 parts of the emulsion (2-4) is added dropwise thereto over 40 minutes.

After completion of the dropwise addition, the solution is retained for 60 minutes, 6 parts of ammonium persulfate having a concentration of 10% by mass is added thereto, and the mixture is retained for another 3 hours and then cooled to room temperature. Thereafter, deionized water and nitric acid are added thereto so that the concentration of solid contents is 20% by mass, thereby obtaining an internally-added crosslinked resin particle dispersion (2).

A volume-average particle size of the obtained resin particles is 166 nm. In addition, a glass transition temperature measured with a differential scanning calorimeter is 13° C.

### Preparation of Emulsions (3-1 to 3-4)

### Emulsion (3-1)

Styrene: 55.9 parts
n-Butyl acrylate: 42.6 parts
1,10-Decanediol diacrylate: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (3-1).

### Emulsion (3-2)

Styrene: 62.9 parts
n-Butyl acrylate: 35.6 parts
1,10-Decanediol diacrylate: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (3-2).

### Emulsion (3-3)

Styrene: 76.9 parts
n-Butyl acrylate: 21.6 parts
1,10-Decanediol diacrylate: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (3-3).

### Emulsion (3-4)

Styrene: 83.9 parts
n-Butyl acrylate: 14.6 parts
1,10-Decanediol diacrylate: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (3-4).

### Preparation of Internally-Added Crosslinked Resin Particle Dispersion (3)

An internally-added crosslinked resin particle dispersion (3) is obtained in the same manner as in the preparation of the internally-added crosslinked resin particle dispersion (1), except that the emulsion (1-1) is changed to the emulsion (3-1), the emulsion (1-2) is changed to the emulsion (3-2), the emulsion (1-3) is changed to the emulsion (3-3), and the emulsion (1-4) is changed to the emulsion (3-4).

A volume-average particle size of the obtained resin particles is 164 nm. In addition, a glass transition temperature measured with a differential scanning calorimeter is 51° C.

### Preparation of Internally-added Crosslinked Resin Particle Dispersion (4)

An internally-added crosslinked resin particle dispersion (4) is obtained in the same manner as in the preparation of the internally-added crosslinked resin particle dispersion (1), except that the amount of the anionic surfactant (ELEMINOL MON-2) is changed from 1.2 parts to 4.4 parts.

A volume-average particle size of the obtained resin particles is 100 nm. In addition, a glass transition temperature measured with a differential scanning calorimeter is 18° C.

### Preparation of Internally-Added Crosslinked Resin Particle Dispersion (5)

An internally-added crosslinked resin particle dispersion (5) is obtained in the same manner as in the preparation of the internally-added crosslinked resin particle dispersion (1), except that the amount of the anionic surfactant (ELEMINOL MON-2) is changed from 1.2 parts to 2.7 parts.

A volume-average particle size of the obtained resin particles is 120 nm. In addition, a glass transition temperature measured with a differential scanning calorimeter is 18° C.

### Preparation of Internally-Added Crosslinked Resin Particle Dispersion (6)

An internally-added crosslinked resin particle dispersion (6) is obtained in the same manner as in the preparation of the internally-added crosslinked resin particle dispersion (1), except that the amount of the anionic surfactant (ELEMINOL MON-2) is changed from 1.2 parts to 0.34 parts.

A volume-average particle size of the obtained resin particles is 250 nm. In addition, a glass transition temperature measured with a differential scanning calorimeter is 18° C.

### Preparation of Internally-added Crosslinked Resin Particle Dispersion (7)

An internally-added crosslinked resin particle dispersion (7) is obtained in the same manner as in the preparation of the internally-added crosslinked resin particle dispersion (1), except that the amount of the anionic surfactant (ELEMINOL MON-2) is changed from 1.2 parts to 0.20 parts.

A volume-average particle size of the obtained resin particles is 300 nm. In addition, a glass transition temperature measured with a differential scanning calorimeter is 18° C.

### Preparation of Emulsions (8-1) to (8-4)

### Emulsion (8-1)

Styrene: 40 parts
n-Butyl acrylate: 60 parts
1,10-Decanediol diacrylate: 0.05 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (8-1).

### Emulsion (8-2)

Styrene: 45 parts
n-Butyl acrylate: 55 parts
1,10-Decanediol diacrylate: 0.05 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (8-2).

### Emulsion (8-3)

Styrene: 55 parts
n-Butyl acrylate: 45 parts
1,10-Decanediol diacrylate: 0.05 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (8-3).

### Emulsion (8-4)

Styrene: 60 parts
n-Butyl acrylate: 40 parts
1,10-Decanediol diacrylate: 0.05 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (8-4).

### Preparation of Internally-Added Crosslinked Resin Particle Dispersion (8)

An internally-added crosslinked resin particle dispersion (8) is obtained in the same manner as in the preparation of the internally-added crosslinked resin particle dispersion (1), except that the emulsion (1-1) is changed to the emulsion (8-1), the emulsion (1-2) is changed to the emulsion (8-2), the emulsion (1-3) is changed to the emulsion (8-3), and the emulsion (1-4) is changed to the emulsion (8-4).

A volume-average particle size of the obtained resin particles is 167 nm. In addition, a glass transition temperature measured with a differential scanning calorimeter is 8° C.

### Preparation of Emulsions (9-1) to (9-4)

### Emulsion (9-1)

Styrene: 60.3 parts
n-Butyl acrylate: 38.2 parts
1,10-Decanediol diacrylate: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (9-1).

### Emulsion (9-2)

Styrene: 67.8 parts
n-Butyl acrylate: 30.7 parts
1,10-Decanediol diacrylate: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (9-2).

### Emulsion (9-3)

Styrene: 82.9 parts
n-Butyl acrylate: 15.6 parts
1,10-Decanediol diacrylate: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (9-3).

### Emulsion (9-4)

Styrene: 90.4 parts
n-Butyl acrylate: 8.1 parts
1,10-Decanediol diacrylate: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (9-4).

### Preparation of Internally-Added Crosslinked Resin Particle Dispersion (9)

An internally-added crosslinked resin particle dispersion (9) is obtained in the same manner as in the preparation of the internally-added crosslinked resin particle dispersion (1), except that the emulsion (1-1) is changed to the emulsion (9-1), the emulsion (1-2) is changed to the emulsion (9-2), the emulsion (1-3) is changed to the emulsion (9-3), and the emulsion (1-4) is changed to the emulsion (9-4).

A volume-average particle size of the obtained resin particles is 166 nm. In addition, a glass transition temperature measured with a differential scanning calorimeter is 60° C.

### Preparation of Internally-Added Crosslinked Resin Particle Dispersion (10)

An internally-added crosslinked resin particle dispersion (10) is obtained in the same manner as in the preparation of the internally-added crosslinked resin particle dispersion (1), except that the amount of the anionic surfactant (ELEMINOL MON-2) is changed from 1.2 parts to 5.98 parts.

A volume-average particle size of the obtained resin particles is 90 nm. In addition, a glass transition temperature measured with a differential scanning calorimeter is 18° C.

### Preparation of Internally-Added Crosslinked Resin Particle Dispersion (11)

An internally-added crosslinked resin particle dispersion (11) is obtained in the same manner as in the preparation of the internally-added crosslinked resin particle dispersion (1), except that the amount of the anionic surfactant (ELEMINOL MON-2) is changed from 1.2 parts to 0.17 parts.

A volume-average particle size of the obtained resin particles is 320 nm. In addition, a glass transition temperature measured with a differential scanning calorimeter is 14° C.

### Preparation of Internally-added Crosslinked Resin Particle Dispersion (C6)

Styrene: 47.9 parts
n-Butyl acrylate: 51.8 parts
2-Carboxyethyl acrylate: 0.3 parts
Anionic surfactant (Dowfax2A1 manufactured by The Dow Chemical Company): 0.8 parts
1,10-Decanediol diacrylate: 1.65 parts

The above-described raw materials are mixed together and dissolved, and 60 parts of deionized water is added thereto, followed by dispersion and emulsification in the flask, thereby producing an emulsion.

Subsequently, 1.3 parts of an anionic surfactant (DOWFAX 2A1 manufactured by The Dow Chemical Company) is dissolved in 90 parts of deionized water, 1 part of the above-described emulsion is added thereto, and 10 parts of deionized water in which 5.4 parts of ammonium persulfate is dissolved is further added thereto.

Thereafter, the rest of the emulsion is added thereto for 180 minutes, the flask is replaced with nitrogen by purging, the solution in the flask is heated up to 65° C. in an oil bath while being stirred, the emulsion polymerization is continued in the state for 500 hours, and then the solid content thereof is adjusted to 24.5% by mass, thereby obtaining an internally-added crosslinked resin particle dispersion (C6).

A volume-average particle size of the obtained resin particles is 165 nm. In addition, a glass transition temperature measured with a differential scanning calorimeter is 14° C.

### Preparation of Amorphous Polyester Resin Particle Dispersion (1-1)

Terephthalic acid: 28 parts by mole
Isophthalic acid: 15 parts by mole
Adipic acid: 5 parts by mole
Trimellitic anhydride: 2 parts by mole
Propylene oxide (2 μmol) adduct of bisphenol A: 50 parts by mole

The above-described materials are charged into a reaction vessel equipped with a stirrer, a nitrogen introduction tube, a temperature sensor, and a rectifying column, the temperature is raised to 190° C. over 1 hour, and dibutyltin oxide is added to the mixture in an amount of 1.2 parts with respect to 100 parts of the above-described materials. While the generated water is distilled off, the temperature is raised to 240° C. for 6 hours, a dehydration condensation reaction is continued for 3 hours in the reaction solution retained at 240° C., and then the reactant is cooled to obtain an amorphous polyester resin (1).

The amorphous polyester resin (1) has an acid value of 10.5 and a glass transition temperature of 59.0° C.
Amorphous polyester resin (1): 100 parts
Methyl ethyl ketone: 60 parts
Isopropanol: 10 parts
10% Aqueous ammonia solution: 3.5 parts

The above-described materials are put in a jacketed reaction tank equipped with a condenser, a thermometer, a water dripping device, and an anchor blade, and in a state in which the reaction tank is retained at a liquid temperature of 50° C. in a water-circulation type thermostatic bath, the amorphous polyester resin (1) is dissolved while stirring and mixing the mixture at 100 rpm. Next, the water-circulation type thermostatic bath is set to 40° C., and a total of 300 parts of deionized water retained at 40° C. is added dropwise to the reaction tank at a rate of 3 parts/min to cause phase inversion, thereby obtaining an emulsion.

The obtained emulsion is added to an eggplant flask, and the eggplant flask is set through a trap ball in an evaporator equipped with a vacuum control unit. While being rotated, the eggplant flask is heated in a hot water bath at 60° C., the pressure is reduced to 7 kPa with care to sudden boiling to remove the solvent, and then returned to normal pressure, and the eggplant flask is water-cooled to obtain a dispersion. Deionized water is added to the obtained dispersion, thereby obtaining an amorphous polyester resin particle dispersion (1) having a solid content of 20% by mass. A volume-average particle size of the amorphous polyester resin particles in the amorphous polyester resin particle dispersion (1) is 180 nm.

### Preparation of Amorphous Polyester Resin Particle Dispersion (1-2)

An amorphous polyester resin particle dispersion (1-2) is obtained in the same manner as in the preparation of the amorphous polyester resin particle dispersion (1-1), except that the amount of the methyl ethyl ketone is changed from 60 parts to 120 parts, and the amount of the isopropanol is changed from 10 parts to 20 parts. A volume-average particle size of the amorphous polyester resin particles in the amorphous polyester resin particle dispersion (1-2) is 80 nm.

### Preparation of Amorphous Polyester Resin Particle Dispersion (2-1)

Ethylene oxide (2.2 μmol) adduct of bisphenol A: 40 parts by mole
Propylene oxide (2.2 μmol) adduct of bisphenol A: 60 parts by mole
Dimethyl terephthalate: 60 parts by mole
Dimethyl fumarate: 15 parts by mole
Dodecenyl succinic acid anhydride: 20 parts by mole
Trimellitic acid anhydride: 5 parts by mole

A reaction container equipped with a stirrer, a thermometer, a condenser, and a nitrogen gas introduction pipe is charged with 0.25 parts of dioctanoyltin, other than fumaric acid and trimellitic acid anhydride among the above monomers, with respect to a total of 100 parts of the above monomers. The mixture is allowed to react at 235° C. for 6 hours in a nitrogen gas stream and cooled to 200° C., the fumaric acid and the trimellitic acid anhydride are added to the mixture, and the mixture is allowed to react for 1 hour. The temperature is raised to 220° C. over 5 hours, the mixture is polymerized under a pressure of 10 kPa until a target molecular weight is obtained, and then cooled to obtain an amorphous polyester resin (2).
Amorphous polyester resin (2): 100 parts
Methyl ethyl ketone: 60 parts
Isopropanol: 10 parts
10% Aqueous ammonia solution: 3.5 parts

The above-described materials are put in a jacketed reaction tank equipped with a condenser, a thermometer, a water dripping device, and an anchor blade, and in a state in which the reaction tank is retained at a liquid temperature of 50° C. in a water-circulation type thermostatic bath, the amorphous polyester resin (2) is dissolved while stirring and mixing the mixture at 100 rpm. Next, the water-circulation type thermostatic bath is set to 40° C., and a total of 300 parts of deionized water retained at 40° C. is added dropwise to the reaction tank at a rate of 3 parts/min to cause phase inversion, thereby obtaining an emulsion.

The obtained emulsion is added to an eggplant flask, and the eggplant flask is set through a trap ball in an evaporator equipped with a vacuum control unit. While being rotated, the eggplant flask is heated in a hot water bath at 60° C., the pressure is reduced to 7 kPa with care to sudden boiling to remove the solvent, and then returned to normal pressure, and the eggplant flask is water-cooled to obtain a dispersion. Deionized water is added to the obtained dispersion, thereby obtaining an amorphous polyester resin particle dispersion (2-1) having a solid content of 20% by mass. A volume-average particle size of the amorphous polyester resin particles in the amorphous polyester resin particle dispersion (2-1) is 185 nm.

### Preparation of Amorphous Polyester Resin Particle Dispersion (2-2)

An amorphous polyester resin particle dispersion (2-2) is obtained in the same manner as in the preparation of the amorphous polyester resin particle dispersion (2-1), except that the amount of the methyl ethyl ketone is changed from 60 parts to 120 parts, and the amount of the isopropanol is changed from 10 parts to 20 parts. A volume-average particle size of the amorphous polyester resin particles in the amorphous polyester resin particle dispersion (2-2) is 84 nm.

### Production of Amorphous Polyester Resin Particle Dispersion (C6)

Terephthalic acid: 28 parts
Fumaric acid: 164 parts
Adipic acid: 10 parts
Ethylene oxide (2 mol) adduct of bisphenol A: 26 parts
Propylene oxide (2 mol) adduct of bisphenol A: 542 parts

The above-described materials are charged into a reaction vessel equipped with a stirrer, a nitrogen introduction tube, a temperature sensor, and a rectifying column, the temperature is raised to 190° C. over 1 hour, and dibutyltin oxide is added to the mixture in an amount of 1.2 parts with respect to 100 parts of the above-described materials. While the generated water is distilled off, the temperature is raised to 240° C. for 6 hours, a dehydration condensation reaction is continued for 3 hours in the reaction solution retained at 240° C., and then the reactant is cooled.

The reactant in a molten state is transferred to CAVITRON CD1010 (manufactured by Eurotech Ltd.) at a rate of 100 g/min. At the same time, separately prepared aqueous ammonia having a concentration of 0.37% by mass is transferred to CAVITRON CD1010 at a rate of 0.1 L/min in a state of being heated at 120° C. with a heat exchanger. The CAVITRON CD1010 is operated under the conditions of a rotation speed of a rotor of 60 Hz and a pressure of 5 kg/cm², thereby obtaining a resin particle dispersion in which resin particles of an amorphous polyester resin having a volume-average particle size of 169 nm are dispersed. Deionized water is added to the resin particle dispersion to adjust the solid content to 20% by mass, thereby obtaining an amorphous polyester resin particle dispersion (C6).

### Production of Crystalline Polyester Resin Particle Dispersion (1)

Dodecanedioic acid: 50 parts by mole
1,6-Hexanediol: 50 parts by mole

The above-described materials are charged into a reaction vessel equipped with a stirrer, a nitrogen introduction tube, a temperature sensor, and a rectifying column, the temperature is raised to 160° C. over 1 hour, and dibutyltin oxide is added to the mixture in an amount of 0.8 parts with respect to 100 parts of the above-described materials. While the generated water is distilled off, the temperature is raised to 180° C. over 6 hours, and the mixture is stirred for 5 hours in a state of being kept at 180° C. and refluxed such that the reaction proceeds. Next, the temperature is slowly raised to 230° C. under reduced pressure (3 kPa), and the reaction solution is stirred for 2 hours in a state of being kept at 230° C. Thereafter, the reactant is cooled. After the cooling, solid-liquid separation is performed, and the solids are dried, thereby obtaining a crystalline polyester resin (1). A weight-average molecular weight of the crystalline polyester resin (1) is 29,000.
Crystalline polyester resin (1): 100 parts
Methyl ethyl ketone: 70 parts
Isopropanol: 12 parts
10% Aqueous ammonia solution: 3 parts

The above-described materials are put in a jacketed reaction tank equipped with a condenser, a thermometer, a water dripping device, and an anchor blade, and in a state in which the reaction tank is retained at a liquid temperature of 80° C. in a water-circulation type thermostatic bath, the resin is dissolved while stirring and mixing the mixture at 100 rpm. Next, the water-circulation type thermostatic bath is set to 60° C., and a total of 300 parts of deionized water retained at 60° C. is added dropwise to the reaction tank at a rate of 3 parts/min to cause phase inversion, thereby obtaining an emulsion.

The obtained emulsion is added to an eggplant flask, and the eggplant flask is set through a trap ball in an evaporator equipped with a vacuum control unit. While being rotated, the eggplant flask is heated in a hot water bath at 60° C., the pressure is reduced to 7 kPa with care to sudden boiling to remove the solvent, and then returned to normal pressure, and the eggplant flask is water-cooled to obtain a dispersion. Deionized water is added to the dispersion, thereby obtaining a crystalline polyester resin particle dispersion (1) having a solid content of 20% by mass. A volume-average particle size of the resin particles in the crystalline polyester resin particle dispersion (1) is 160 nm.

### Production of Crystalline Polyester Resin Particle Dispersion (C6)

1,10-Dodecanedioic acid: 225 parts
1,6-Hexanediol: 143 parts

The above-described materials are charged into a reaction vessel equipped with a stirrer, a nitrogen introduction tube, a temperature sensor, and a rectifying column, the temperature is raised to 160° C. over 1 hour, and 0.8 parts by mass of dibutyltin oxide is added thereto. While the generated water is distilled off, the temperature is raised to 180° C. for 6 hours, and a dehydration condensation reaction is continued for 5 hours in the reaction solution retained at 180° C. Thereafter, the temperature is slowly raised to 230° C. under reduced pressure, and the reaction solution is stirred for 2 hours in a state of being retained at 230° C. Thereafter, the reaction product is cooled. After the cooling, solid-liquid separation is performed, and the solids are dried, thereby obtaining a crystalline polyester resin (C6).
Crystalline polyester resin (C6): 100 parts
Methyl ethyl ketone: 40 parts
Isopropyl alcohol: 30 parts
10% Aqueous ammonia solution: 6 parts

The above-described materials are put in a 3 L jacketed reaction tank (manufactured by EYELA: BJ-30N) equipped with a condenser, a thermometer, a water dripping device, and an anchor blade. In a state where the reaction tank is kept at 80° C. in a water-circulation type thermostatic bath, and the materials are stirred and mixed together at 100 rpm, the resin is dissolved. Thereafter, the water-circulation type thermostatic bath is set to 50° C., and a total of 400 parts of deionized water retained at 50° C. is added dropwise to the reaction tank at a rate of 7 parts by mass/min to cause phase inversion, thereby obtaining an emulsion. 576 parts by mass of the obtained emulsion and 500 parts by mass of deionized water are put in a 2 L eggplant flask and set in an evaporator (manufactured by EYELA) equipped with a vacuum controlled unit through a trap ball. While being rotated, the eggplant flask is heated in a hot water bath at 60° C., and the pressure is reduced to 7 kPa with care to sudden boiling, thereby removing the solvent. A volume-average particle size D50v of the resin particles in the dispersion is 185 nm. Thereafter, deionized water is added thereto to obtain a crystalline polyester resin particle dispersion (C6) having a concentration of solid contents of 22.1% by mass.

### Production of Colorant Dispersion (1)

Cyan pigment (Pigment Blue 15:3 (copper phthalocyanine), manufactured by Dainichiseika Color & Chemicals Mfg.Co., Ltd.): 98 parts
Anionic surfactant (TaycaPower manufactured by Tayca Corporation): 2 parts
Deionized water: 400 parts

After mixing the above-described components, the components are dispersed using a homogenizer (ULTRA-TURRAX T50 manufactured by IKA), thereby obtaining a colorant dispersion (1) having a volume-average particle size of 164 nm and a concentration of solid contents of 20% by mass.

### Production of Colorant Dispersion (2)

Carbon black (Regal 330, manufactured by Cabot Corporation.): 98 parts
Anionic surfactant (NEOPELEX G-65, Kao Corporation): 2 parts
Deionized water: 400 parts

After mixing the above-described components, the components are dispersed using a homogenizer (ULTRA-TURRAX T50 manufactured by IKA), thereby obtaining a colorant dispersion (2) having a volume-average particle size of 180 nm and a concentration of solid contents of 20% by mass.

### Production of Release Agent Particle Dispersion (1)

Synthetic wax (FT100, manufactured by NIPPON SEIRO CO., LTD.): 100 parts
Anionic surfactant (NEOPELEX G-65, Kao Corporation): 5 parts
Deionized water: 300 parts

The above-described components are mixed with each other, heated to 100° C., and dispersed using a homogenizer (ULTRA-TURRAX T50 manufactured by IKA). Furthermore, a dispersion treatment is performed using a Manton-Gaulin high-pressure homogenizer (manufactured by Gaulin Corporation), and deionized water is added to the dispersion, thereby obtaining a release agent particle dispersion (1) having a solid content of 20% by mass. A volume-average particle size of the release agent particles in the release agent particle dispersion (1) is 230 nm.

### Production of Release Agent Particle Dispersion (2)

Synthetic wax (manufactured by NIPPON SEIRO CO., LTD., FNP92, melting temperature Tw: 92° C.): 50 parts
Anionic surfactant (TaycaPower manufactured by Tayca Corporation): 1 part
Deionized water: 200 parts

The above-described materials are mixed together, heated to 130° C., and dispersed using a homogenizer (ULTRA-TURRAX T50 manufactured by IKA). Thereafter, using Manton-Gaulin high-pressure homogenizer (manufactured by Gaulin), dispersion treatment is performed, thereby obtaining a release agent particle dispersion (2) (solid content: 20% by mass) in which release agent particles are dispersed. A volume-average particle size of the release agent particles is 214 nm.

### Example 1

### Production of Toner 1

Amorphous polyester resin particle dispersion (1-2) (solid content: 20% by mass): 255 parts
Deionized water: 720 parts

The above-described materials are put in a reaction container 1 equipped with a thermometer, a pH meter, and a stirrer, and a 0.3 N nitric acid aqueous solution is added thereto while stirring at a rotation speed of 35 rpm at a temperature of 20° C., thereby adjusting a pH to 4.5.

Next, 150 parts of the internally-added crosslinked resin particle dispersion (1) (solid content: 20% by mass) is put in a container equipped with a stirrer and a stirring blade, and a 0.3 N nitric acid aqueous solution is added thereto while stirring, thereby adjusting a pH to 4.5.

Next, while maintaining the reaction container 1 at 20° C., the pH-adjusted internally-added crosslinked resin particle dispersion (1) is added dropwise thereto at a rate of 7 g/min while stirring at a rotation speed of 35 rpm.

Next, an aqueous solution of 2% aluminum sulfate is added thereto while dispersing with a homogenizer (ULTRA-TURRAX T50). Next, in a state in which the reaction solution is stirred, the temperature thereof is raised to 30° C. at a rate of 0.4° C./min and retained.

Next, the following materials are put in a container equipped with a stirrer and a stirring blade, and a 0.3 N nitric acid aqueous solution is added thereto while stirring to adjust a pH to 4.5, thereby preparing a material mixed solution.
Amorphous polyester resin particle dispersion (1-1) (solid content: 20% by mass): 255 parts
Crystalline polyester resin particle dispersion (1) (solid content: 20% by mass): 233 parts
Colorant dispersion (1) (solid content: 20% by mass): 104 parts
Release agent particle dispersion (1) (solid content: 20% by mass): 83 parts

Next, the material mixed solution adjusted to a pH of 4.5 is added dropwise to the reaction container 1 held at 30° C. at a rate of 7 g/min.

Next, in a state in which the reaction container 1 is stirred, the temperature thereof is raised to 45° C. at a rate of 0.4° C./min and retained for 30 minutes.

Next, 420 parts of the amorphous polyester resin particle dispersion (1-1) is added thereto, and the mixture is retained for 30 minutes. Next, a 0.1N sodium hydroxide aqueous solution is added thereto such that the pH is adjusted to 8.5, and the reaction solution is retained for 15 minutes, heated to 80° C. at a rate of 1° C./min while being continuously stirred, and retained at 80° C. for 5 hours.

Next, after cooling, solid-liquid separation, and washing of solid matter with deionized water, the solid matter is dried for 24 hours in a freeze vacuum dryer to obtain toner particles (1) having a volume-average particle size of 5.5 μm.

100 parts of the toner particles (1) and 2.0 parts of hydrophobic silica (manufactured by Nippon Aerosil Co., Ltd.; product name: RY200) are mixed with a Henshell mixer to obtain a toner 1.

### Examples 2 to 25 and Comparative Examples 1 to 6

### Production of Toners 2 to 25 and Toners C1 to C4

Toners 2 to 25 and toners C1 to C4 are obtained in the same manner as in the production of the toner 1, except that the type and amount of each resin particle dispersion are changed as shown in Table 1.

### Production of Toner C5

Amorphous polyester resin particle dispersion (1-1): 511 parts
Crystalline polyester resin dispersion (1): 233 parts
Colorant dispersion (1): 104 parts
Release agent particle dispersion (1): 83 parts
Internally-added crosslinked resin particle dispersion (1): 150 parts
Deionized water: 720 parts

The above-described materials are put in a reaction vessel equipped with a thermometer, a pH meter, and a stirrer, and the temperature of the reaction vessel is kept at 20° C. and retained for 30 minutes while stirring at a rotation speed of 150 rpm. Next, a 0.3N nitric acid aqueous solution is added thereto such that the pH is adjusted to 5.0, and then a 2% aluminum sulfate aqueous solution is added thereto in a state in which the reaction solution is dispersed with a homogenizer (ULTRA-TURRAX T50). Next, in a state in which the reaction solution is stirred, the temperature thereof is raised to 45° C. at a rate of 0.4° C./min and retained for 30 minutes.

Next, 420 parts of the amorphous polyester resin particle dispersion (1-1) is added thereto, and the mixture is retained for 30 minutes. Next, a 0.1N sodium hydroxide aqueous solution is added thereto such that the pH is adjusted to 8.5, and the reaction solution is retained for 15 minutes, heated to 80° C. at a rate of 1° C./min while being continuously stirred, and retained at 80° C. for 5 hours. Next, after cooling, solid-liquid separation, and washing of solid matter with deionized water, the solid matter is dried for 24 hours in a freeze vacuum dryer to obtain toner particles (C5) having a volume-average particle size of 5.5 μm.

100 parts of the toner particles (C5) and 2.0 parts of hydrophobic silica (manufactured by Nippon Aerosil Co., Ltd.; product name: RY200) are mixed with a Henshell mixer to obtain a toner C5.

### Production of Toner C6

Amorphous polyester resin particle dispersion (C6): 169 parts
Internally-added crosslinked resin particle dispersion (C6): 33 parts
Crystalline polyester resin particle dispersion (C6): 53 parts
Release agent particle dispersion (2): 25 parts
Colorant dispersion (1): 34.8 parts
Anionic surfactant (Dowfax2A1 manufactured by The Dow Chemical Company): 4.8 parts

The above-described materials with a liquid temperature adjusted to 10° C. are put in a 3 L cylindrical stainless steel container, and dispersed and mixed together for 2 minutes in a state where a shearing force is applied at 4,000 rpm by a homogenizer (ULTRA-TURRAX T50 manufactured by IKA).

Next, 1.75 parts of a 10% nitric acid aqueous solution of aluminum sulfate as an aggregating agent is slowly added dropwise to the mixture, and dispersed and mixed for 10 minutes by the homogenizer at a rotation speed of 10,000 rpm, thereby obtaining a raw material dispersion.

Thereafter, the raw material dispersion is moved to a polymerization tank equipped with a stirrer using two paddles as stirring blades and a thermometer, and start to be heated with a mantle heater at a rotation speed for stirring of 550 rpm, and then the growth of aggregated particles is promoted at 40° C. In this case, by using an aqueous solution of 0.3 M nitric acid and 1 M sodium hydroxide, the pH of the raw material dispersion is controlled in a range of 2.2 to 3.5. The raw material dispersion is retained in the above-described pH range for approximately 2 hours so that aggregated particles are formed.

Next, a dispersion obtained by mixing 21 parts of the amorphous polyester resin particle dispersion (C6) and 8 parts of the internally-added crosslinked resin particle dispersion (C6) is added thereto, and the mixture is retained for 60 minutes, thereby attaching the resin particles of the binder resin and the internally-added crosslinked resin particles (C6) to the surface of the above-described aggregated particles. The dispersion is further heated to 53° C., 21 parts of the amorphous polyester resin particle dispersion (C6) is further added thereto, and the obtained dispersion is retained for 60 minutes so that the binder resin particles adhere to the surface of the aggregated particles.

The aggregated particles are prepared in a state in which the size and shape of particles are checked using an optical microscope and MULTISIZER 3. Thereafter, pH is adjusted to 7.8 using a 5% aqueous sodium hydroxide solution, and the dispersion is retained for 15 minutes.

Thereafter, the pH is raised to 8.0 so that the aggregated particles are coalesced, and then the dispersion is heated up to 85° C. Two hours after the coalesce of the aggregated particles is confirmed using an optical microscope, heating is stopped, and the dispersion is cooled at a cooling rate of 1.0° C./min. Subsequently, the particles are sieved with a 20 μm mesh, repeatedly washed with water, and then dried in a vacuum dryer, thereby obtaining toner particles (C6) having a volume-average particle size of 5.3 μm.

100 parts of the toner particles (C6) and 2.0 parts of hydrophobic silica (manufactured by Nippon Aerosil Co., Ltd.; product name: RY200) are mixed with a Henshell mixer to obtain a toner C6.

The following items of the toners obtained in Examples 1 to 25 and Comparative Examples 1 to 6 are shown. The methods for measuring the characteristics of the toner are as described above.
slope F(16)
Content of the crystalline polyester resin with respect to the binder resin
Content We of the crystalline polyester resin with respect to the toner particles
Content Ws of the internally-added crosslinked resin particles with respect to the toner particles
Storage elastic modulus G′ of the internally-added crosslinked resin particles (styrene-(meth)acrylic copolymer particles; StAc particles) in a range of 60° C. or higher and 100° C. or lower
Average dispersion size of the internally-added crosslinked resin particles
Area ratio of the internally-added crosslinked resin particles to the cross section of the toner particles in the cross-sectional observation of the toner particles
Dielectric loss factor of the toner after being left to stand at a temperature of 28° C. and a relative humidity of 85% RH at 1 kHz

### Evaluation

### Production of Developer

8 parts of each toner obtained in each example and 92 parts of the following carrier are mixed to obtain a developer. The obtained developer is used for the evaluations described below.

### Production of Carrier

Ferrite particles (average particle size: 35 μm): 100 parts
Toluene: 14 parts
Styrene/methyl methacrylate copolymer (copolymerization ratio: 15/85) 3 parts
Carbon black: 0.2 parts

The above-described components excluding the ferrite particles are dispersed with a sand mill, thereby preparing a dispersion. The dispersion is put in a vacuum deaerating kneader together with the ferrite particles, and dried under reduced pressure while being stirred, thereby obtaining a carrier.

### Low-temperature Fixability

A developing device of a color copy machine Apeos C6570 (manufactured by FUJIFILM Business Innovation Corp.) from which a fixing device has been detached is filled with the obtained developer, a toner application amount is adjusted to 9.0 mg/cm², and an unfixed image is printed out. Colotech 90 paper (manufactured by Xerox Corporation, basis weight: 90 gsm) is used as a recording medium. The image printed out is an image having a size of 50 mm×50 mm and an image density of 100%.

Thereafter, an unfixed image is fixed by a fixing evaluation device, and the low-temperature fixability is evaluated. As a fixing device, a modified device in which a fixer of Apeos C6570 manufactured by FUJIFILM Business Innovation Corp. is detached and the fixing temperature can be changed is used. The fixing temperature is raised from 120° C. to 190° C. in increments of 5° C., and the temperature at which image defect due to offset (phenomenon in which the toner adheres to the fixing member due to insufficient melting of the toner) does not occur is defined as the minimum fixing temperature, and the low-temperature fixability is evaluated according to the following standard. As for the evaluation, the grade up to C is regarded as an acceptable range.
A: minimum fixing temperature is 145° C. or lower.
B: minimum fixing temperature is higher than 145° C. and 155° C. or lower.
C: minimum fixing temperature is higher than 155° C. and 165° C. or lower.
D: minimum fixing temperature is 165° C. or higher.

### Transfer Unevenness in High-Temperature and High-Humidity Environment

Each produced developer is filled in a developing device of a modified machine of a color copier Apeos Port-VC5585 (manufactured by FUJIFILM Business Innovation Corp.) as an image evaluation device.

The image is formed by setting the fixing temperature to the above-described minimum fixing temperature+15° C. using the image evaluation device. Specifically, in an environment of a temperature of 28° C. and a relative humidity of 85% RH, 100,000 sheets of C2 paper A4 are continuously printed with an image having an image density of 1%. Thereafter, the paper is left in the same environment for 24 hours while being placed in the tray, and in the first morning, 10 sheets of full halftone images having an image density of 80% are printed on C2 paper A4. The density of the image printed on the tenth sheet is randomly measured at 10 points with an image densitometer X-Rite 938 (manufactured by X-Rite, Inc.), a difference in image density, that is a difference between the maximum value and the minimum value, is obtained, and the image density unevenness is evaluated based on the following standard. As for the evaluation, the grade up to C is regarded as an acceptable range.
A+: difference in image density is 1% or less.
A: difference in image density is 5% or less.
B: difference in image density is more than 5% and 8% or less.
C: difference in image density is more than 8% and 10% or less.
D: difference in image density is more than 10%.

TABLE 1-1

| | | Toner production conditions | | | | | | | |
|---|---|---|---|---|---|---|---|---|---|
| | | Charging (for forming core) | | | | | | | |
| | | | | Release | | Small-diameter | | Large-diameter | |
| | | | | agent | | amorphous PES | | amorphous PES | |
| | | Colorant | | particle | | resin particle | | resin particle | |
| | | dispersion | | dispersion | | dispersion | | dispersion | |
| | | | Amount | | Amount | | Amount | | Amount |
| | | | (part | | (part | | (part | | (part |
| | | Type | amount) | Type | amount) | Type | amount) | Type | amount) |
| Example 1 | Toner 1 | (1) | 104 | (1) | 83 | (1-2) | 255 | (1-1) | 255 |
| Example 2 | Toner 2 | (1) | 104 | (1) | 83 | (1-2) | 255 | (1-1) | 255 |
| Example 3 | Toner 3 | (1) | 104 | (1) | 83 | (1-2) | 255 | (1-1) | 255 |
| Example 4 | Toner 4 | (1) | 104 | (1) | 83 | (1-2) | 255 | (1-1) | 255 |
| Example 5 | Toner 5 | (1) | 104 | (1) | 83 | (1-2) | 255 | (1-1) | 255 |
| Example 6 | Toner 6 | (1) | 104 | (1) | 83 | (1-2) | 255 | (1-1) | 255 |
| Example 7 | Toner 7 | (1) | 104 | (1) | 83 | (1-2) | 255 | (1-1) | 255 |
| Example 8 | Toner 8 | (1) | 104 | (1) | 83 | (1-2) | 66 | (1-1) | 444 |
| Example 9 | Toner 9 | (1) | 104 | (1) | 83 | (1-2) | 169 | (1-1) | 342 |
| Example 10 | Toner 10 | (1) | 104 | (1) | 83 | (1-2) | 354 | (1-1) | 354 |
| Example 11 | Toner 11 | (1) | 104 | (1) | 83 | (1-2) | 337 | (1-1) | 337 |
| Example 12 | Toner 12 | (1) | 104 | (1) | 83 | (1-2) | 94 | (1-1) | 94 |
| Example 13 | Toner 13 | (1) | 104 | (1) | 83 | (1-2) | 89 | (1-1) | 89 |
| Example 14 | Toner 14 | (1) | 104 | (1) | 83 | (1-2) | 164 | (1-1) | 164 |
| Example 15 | Toner 15 | (1) | 104 | (1) | 83 | (1-2) | 183 | (1-1) | 183 |
| Example 16 | Toner 16 | (1) | 104 | (1) | 83 | (1-2) | 210 | (1-1) | 210 |
| Example 17 | Toner 17 | (1) | 104 | (1) | 83 | (1-2) | 194 | (1-1) | 194 |
| Example 18 | Toner 18 | (1) | 104 | (1) | 83 | (1-2) | 189 | (1-1) | 189 |
| Example 19 | Toner 19 | (1) | 104 | (1) | 83 | (1-2) | 321 | (1-1) | 321 |
| Example 20 | Toner 20 | (1) | 104 | (1) | 83 | (1-2) | 321 | (1-1) | 321 |
| Example 21 | Toner 21 | (1) | 104 | (1) | 83 | (1-2) | 95 | (1-1) | 95 |
| Example 22 | Toner 22 | (1) | 104 | (1) | 83 | (1-2) | 93 | (1-1) | 93 |
| Example 23 | Toner 23 | (1) | 104 | (1) | 83 | (1-2) | 255 | (1-1) | 255 |
| Example 24 | Toner 24 | (1) | 104 | (1) | 83 | (1-2) | 255 | (1-1) | 255 |
| Example 25 | Toner 25 | (2) | 104 | (1) | 83 | (2-2) | 255 | (2-1) | 255 |
| Comparative | Toner C1 | (1) | 104 | (1) | 83 | (1-2) | 255 | (1-1) | 255 |
| Example 1 | | | | | | | | | |
| Comparative | Toner C2 | (1) | 104 | (1) | 83 | (1-2) | 255 | (1-1) | 255 |
| Example 2 | | | | | | | | | |
| Comparative | Toner C3 | (1) | 104 | (1) | 83 | (1-2) | 255 | (1-1) | 255 |
| Example 3 | | | | | | | | | |
| Comparative | Toner C4 | (1) | 104 | (1) | 83 | (1-2) | 255 | (1-1) | 255 |
| Example 4 | | | | | | | | | |
| Comparative | Toner C5 | (1) | 104 | (1) | 83 | | | (1-1) | 511 |
| Example 5 | | | | | | | | | |
| Comparative | Toner C6 | production conditions are as described in (Production of Toner C6) | | | | | | | |
| Example 6 | | | | | | | | | |

| | Toner production conditions | | | | | | |
|---|---|---|---|---|---|---|---|
| | | | | | For forming | | |
| | Charging (for forming core) | | | | shell part | | |
| | Crystalline | | Internally-added | | Large-diameter | | Aggregation |
| | PES resin | | crosslinked resin | | amorphous PES | | stop |
| | particle | | particle | | resin particle | | 0.1N Sodium |
| | dispersion | | dispersion | | dispersion | | hydroxide |
| | | Amount | | Amount | | Amount | added for |
| | | (part | | (part | | (part | adjusting pH |
| | Type | amount) | Type | amount) | Type | amount) | pH |
| Example 1 | (1) | 233 | (1) | 150 | (1-1) | 420 | 8.5 |
| Example 2 | (1) | 233 | (2) | 150 | (1-1) | 420 | 8.5 |
| Example 3 | (1) | 233 | (3) | 150 | (1-1) | 420 | 8.5 |
| Example 4 | (1) | 233 | (4) | 150 | (1-1) | 420 | 8.5 |
| Example 5 | (1) | 233 | (5) | 150 | (1-1) | 420 | 8.5 |
| Example 6 | (1) | 233 | (6) | 150 | (1-1) | 420 | 8.5 |
| Example 7 | (1) | 233 | (7) | 150 | (1-1) | 420 | 8.5 |
| Example 8 | (1) | 233 | (1) | 150 | (1-1) | 420 | 8.5 |
| Example 9 | (1) | 233 | (1) | 150 | (1-1) | 420 | 8.5 |
| Example 10 | (1) | 111 | (1) | 150 | (1-1) | 420 | 8.5 |
| Example 11 | (1) | 122 | (1) | 97.5 | (1-1) | 420 | 8.5 |
| Example 12 | (1) | 405 | (1) | 300 | (1-1) | 420 | 8.5 |
| Example 13 | (1) | 416 | (1) | 300 | (1-1) | 420 | 8.5 |
| Example 14 | (1) | 499 | (1) | 65.3 | (1-1) | 420 | 8.5 |
| Example 15 | (1) | 423 | (1) | 105 | (1-1) | 420 | 8.5 |
| Example 16 | (1) | 210 | (1) | 262.5 | (1-1) | 420 | 8.5 |
| Example 17 | (1) | 202 | (1) | 303 | (1-1) | 420 | 8.5 |
| Example 18 | (1) | 200 | (1) | 315 | (1-1) | 420 | 8.5 |
| Example 19 | (1) | 188 | (1) | 63 | (1-1) | 420 | 8.5 |
| Example 20 | (1) | 187 | (1) | 65.3 | (1-1) | 420 | 8.5 |
| Example 21 | (1) | 328 | (1) | 375 | (1-1) | 420 | 8.5 |
| Example 22 | (1) | 326 | (1) | 383 | (1-1) | 420 | 8.5 |
| Example 23 | (1) | 233 | (1) | 150 | (1-1) | 420 | 9 |
| Example 24 | (1) | 233 | (1) | 150 | (1-1) | 420 | 9.5 |
| Example 25 | (1) | 233 | (1) | 150 | (2-2) | 420 | 8.5 |
| Comparative | (1) | 233 | (8) | 150 | (1-1) | 420 | 8.5 |
| Example 1 | | | | | | | |
| Comparative | (1) | 233 | (9) | 150 | (1-1) | 420 | 8.5 |
| Example 2 | | | | | | | |
| Comparative | (1) | 233 | (10) | 150 | (1-1) | 420 | 8.5 |
| Example 3 | | | | | | | |
| Comparative | (1) | 233 | (11) | 150 | (1-1) | 420 | 8.5 |
| Example 4 | | | | | | | |
| Comparative | (1) | 233 | (1) | 150 | (1-1) | 420 | 8.5 |
| Example 5 | | | | | | | |
| Comparative | production conditions are as described in (Production of Toner C6) | | | | | | |
| Example 6 | | | | | | | |

TABLE 1-2

| | | Toner characters | | | | |
|---|---|---|---|---|---|---|
| | | | | Internally-added crosslinked resin | | |
| | | Amorphous PES resin | | particles (StAc resin particles) | | |
| | | Content | Content Wc | | Content Ws | |
| | | (% by mass, | (% by mass, | | (% by mass, | |
| | | with respect | with respect | Storage elastic | with respect | |
| | | to binder | to toner | modulus G′ | to toner | |
| | | resin) | particles) | (Pa) | particles) | Ws/Wc |
| Example 1 | Toner 1 | 20 | 15.51 | 60° C.: 3.5 × 10\hat{ }5 | 10 | 0.64 |
| | | | | 100° C.: 2.8 × 10\hat{ }5 | | |
| Example 2 | Toner 2 | 20 | 15.51 | 60° C.: 1.7 × 10\hat{ }5 | 10 | 0.64 |
| | | | | 100° C.: 1.0 × 10\hat{ }5 | | |
| Example 3 | Toner 3 | 20 | 15.51 | 60° C.: 1.0 × 10\hat{ }6 | 10 | 0.64 |
| | | | | 100° C.: 9.2 × 10\hat{ }5 | | |
| Example 4 | Toner 4 | 20 | 15.51 | 60° C.: 3.5 × 10\hat{ }5 | 10 | 0.64 |
| | | | | 100° C.: 2.8 × 10\hat{ }5 | | |
| Example 5 | Toner 5 | 20 | 15.51 | 60° C.: 3.5 × 10\hat{ }5 | 10 | 0.64 |
| | | | | 100° C.: 2.8 × 10\hat{ }5 | | |
| Example 6 | Toner 6 | 20 | 15.51 | 60° C.: 3.5 × 10\hat{ }5 | 10 | 0.64 |
| | | | | 100° C.: 2.8 × 10\hat{ }5 | | |
| Example 7 | Toner 7 | 20 | 15.51 | 60° C.: 3.5 × 10\hat{ }5 | 10 | 0.64 |
| | | | | 100° C.: 2.8 × 10\hat{ }5 | | |
| Example 8 | Toner 8 | 20 | 15.51 | 60° C.: 3.5 × 10\hat{ }5 | 10 | 0.64 |
| | | | | 100° C.: 2.8 × 10\hat{ }5 | | |
| Example 9 | Toner 9 | 20 | 15.51 | 60° C.: 3.5 × 10\hat{ }5 | 10 | 0.64 |
| | | | | 100° C.: 2.8 × 10\hat{ }5 | | |
| Example 10 | Toner 10 | 9 | 7.43 | 60° C.: 3.5 × 10\hat{ }5 | 5 | 0.67 |
| | | | | 100° C.: 2.8 × 10\hat{ }5 | | |
| Example 11 | Toner 11 | 10 | 8.11 | 60° C.: 3.5 × 10\hat{ }5 | 6.5 | 0.80 |
| | | | | 100° C.: 2.8 × 10\hat{ }5 | | |
| Example 12 | Toner 12 | 40 | 27.03 | 60° C.: 3.5 × 10\hat{ }5 | 20 | 0.74 |
| | | | | 100° C.: 2.8 × 10\hat{ }5 | | |
| Example 13 | Toner 13 | 41 | 27.70 | 60° C.: 3.5 × 10\hat{ }5 | 20 | 0.72 |
| | | | | 100° C.: 2.8 × 10\hat{ }5 | | |
| Example 14 | Toner 14 | 40 | 33.29 | 60° C.: 3.5 × 10\hat{ }5 | 4.35 | 0.13 |
| | | | | 100° C.: 2.8 × 10\hat{ }5 | | |
| Example 15 | Toner 15 | 35 | 28.18 | 60° C.: 3.5 × 10\hat{ }5 | 7 | 0.25 |
| | | | | 100° C.: 2.8 × 10\hat{ }5 | | |
| Example 16 | Toner 16 | 20 | 14.01 | 60° C.: 3.5 × 10\hat{ }5 | 17.5 | 1.25 |
| | | | | 100° C.: 2.8 × 10\hat{ }5 | | |
| Example 17 | Toner 17 | 20 | 13.47 | 60° C.: 3.5 × 10\hat{ }5 | 20.2 | 1.50 |
| | | | | 100° C.: 2.8 × 10\hat{ }5 | | |
| Example 18 | Toner 18 | 20 | 13.31 | 60° C.: 3.5 × 10\hat{ }5 | 21 | 1.58 |
| | | | | 100° C.: 2.8 × 10\hat{ }5 | | |
| Example 19 | Toner 19 | 15 | 12.51 | 60° C.: 3.5 × 10\hat{ }5 | 4.2 | 0.34 |
| | | | | 100° C.: 2.8 × 10\hat{ }5 | | |
| Example 20 | Toner 20 | 15 | 12.48 | 60° C.: 3.5 × 10\hat{ }5 | 4.35 | 0.35 |
| | | | | 100° C.: 2.8 × 10\hat{ }5 | | |
| Example 21 | Toner 21 | 35 | 21.89 | 60° C.: 3.5 × 10\hat{ }5 | 25.0 | 1.14 |
| | | | | 100° C.: 2.8 × 10\hat{ }5 | | |
| Example 22 | Toner 22 | 35 | 21.72 | 60° C.: 3.5 × 10\hat{ }5 | 25.5 | 1.17 |
| | | | | 100° C.: 2.8 × 10\hat{ }5 | | |
| Example 23 | Toner 23 | 20 | 15.51 | 60° C.: 3.5 × 10\hat{ }5 | 10 | 0.64 |
| | | | | 100° C.: 2.8 × 10\hat{ }5 | | |
| Example 24 | Toner 24 | 20 | 15.51 | 60° C.: 3.5 × 10\hat{ }5 | 10 | 0.64 |
| | | | | 100° C.: 2.8 × 10\hat{ }5 | | |
| Example 25 | Toner 25 | 20 | 15.51 | 60° C.: 3.5 × 10\hat{ }5 | 10 | 0.64 |
| | | | | 100° C.: 2.8 × 10\hat{ }5 | | |
| Comparative | Toner C1 | 20 | 15.51 | 60° C.: 9.5 × 10\hat{ }4 | 10 | 0.64 |
| Example 1 | | | | 100° C.: 8.5 × 10\hat{ }4 | | |
| Comparative | Toner C2 | 20 | 15.51 | 60° C.: 1.8 × 10\hat{ }6 | 10 | 0.64 |
| Example 2 | | | | 100° C.: 0.78 × 10\hat{ }6 | | |
| Comparative | Toner C3 | 20 | 15.51 | 60° C.: 3.5 × 10\hat{ }5 | 10 | 0.64 |
| Example 3 | | | | 100° C.: 2.8 × 10\hat{ }5 | | |
| Comparative | Toner C4 | 20 | 15.51 | 60° C.: 3.5 × 10\hat{ }5 | 10 | 0.64 |
| Example 4 | | | | 100° C.: 2.8 × 10\hat{ }5 | | |
| Comparative | Toner C5 | 20 | 15.51 | 60° C.: 3.5 × 10\hat{ }5 | 10 | 0.64 |
| Example 5 | | | | 100° C.: 2.8 × 10\hat{ }5 | | |
| Comparative | Toner C6 | 15 | 10.6 | 60° C.: 3.8 × 10\hat{ }5 | 10 | 0.94 |
| Example 6 | | | | 100° C.: 3.0 × 10\hat{ }5 | | |

| | | | | | Evaluation | |
|---|---|---|---|---|---|---|
| | Toner characters | | | | Low- | |
| | Internally-added crosslinked resin | | | | temperature | |
| | particles (StAc resin particles) | | | | fixability | |
| | Average | | | | (minimum | |
| | dispersion | Area | | Dielectric | fixing | |
| | size | ratio | slope | loss factor | temperature, | Transfer |
| | (nm) | (%) | F(16) | (×10⁻³) | ° C.) | unevenness |
| Example 1 | 165 | 26 | 0.92 | 20 | B | A+ |
| Example 2 | 166 | 26 | 0.80 | 25 | B | C |
| Example 3 | 164 | 26 | 0.85 | 25 | C | B |
| Example 4 | 100 | 26 | 0.80 | 24 | B | B |
| Example 5 | 120 | 26 | 0.82 | 22 | B | A |
| Example 6 | 250 | 26 | 0.81 | 22 | B | A |
| Example 7 | 300 | 26 | 0.78 | 24 | B | B |
| Example 8 | 165 | 26 | 0.60 | 25 | B | C |
| Example 9 | 165 | 26 | 0.70 | 23 | B | A |
| Example 10 | 165 | 16.4 | 0.72 | 24 | C | B |
| Example 11 | 165 | 19.5 | 0.71 | 21 | C | A |
| Example 12 | 165 | 41.4 | 0.92 | 22 | A | A |
| Example 13 | 165 | 41.4 | 0.89 | 23 | A | B |
| Example 14 | 165 | 15 | 0.75 | 24 | A | C |
| Example 15 | 165 | 20.6 | 0.71 | 21 | A | A |
| Example 16 | 165 | 37.9 | 0.85 | 22 | B | A |
| Example 17 | 165 | 41.6 | 0.89 | 23 | B | B |
| Example 18 | 165 | 42.7 | 0.85 | 24 | B | C |
| Example 19 | 165 | 14.6 | 0.72 | 24 | B | B |
| Example 20 | 165 | 15 | 0.75 | 22 | B | A |
| Example 21 | 165 | 48 | 0.81 | 25 | A | A |
| Example 22 | 165 | 48.6 | 0.83 | 28 | A | B |
| Example 23 | 165 | 26 | 0.90 | 35 | A | B |
| Example 24 | 165 | 26 | 0.90 | 37 | A | C |
| Example 25 | 165 | 26 | 0.90 | 30 | B | A+ |
| Comparative | 165 | 26 | 0.50 | 37 | B | D |
| Example 1 | | | | | | |
| Comparative | 165 | 26 | 0.85 | 24 | D | B |
| Example 2 | | | | | | |
| Comparative | 90 | 26 | 0.88 | 31 | B | D |
| Example 3 | | | | | | |
| Comparative | 320 | 26 | 0.89 | 32 | B | D |
| Example 4 | | | | | | |
| Comparative | 165 | 26 | 0.55 | 30 | B | D |
| Example 5 | | | | | | |
| Comparative | 165 | 26 | 0.58 | 28 | B | D |
| Example 6 | | | | | | |

From the above results, it is found that the toners of the present example can suppress the transfer unevenness in a high-temperature and high-humidity environment while having low-temperature fixability, as compared with the toners of the comparative examples.

The present exemplary embodiments include the following aspects.

(((1)))

An electrostatic charge image developing toner comprising:
toner particles that contain an amorphous polyester resin and a crystalline polyester resin as a binder resin and internally-added crosslinked resin particles,
wherein the internally-added crosslinked resin particles are styrene-(meth)acrylic copolymer particles in which a storage elastic modulus G′ in a range of 60° C. or higher and 100° C. or lower is 1×10⁵ Pa or more and 1×10⁶ Pa or less,
an average dispersion size of the internally-added crosslinked resin particles is 100 nm or more and 300 nm or less, and
in a case where a square region of 3 μm×3 μm having a size of 600 pix×600 pix in a cross-sectional observation of the toner particles is divided into n×n regions, in the n×n divided regions, the following expression (1) is satisfied from DAR(n) that is a coefficient of variation of an area ratio of the internally-added crosslinked resin particles to an area of the divided regions and slope F(16) that is a slope of an approximate straight line in a dispersion diagram obtained by changing the n to 3, 4, 6, 8, 12, and 16 and plotting log[1/n] on an X-axis and log[DAR(n)] on a Y-axis,

0.6≤slope F(16). expression (1):

(((2)))

The electrostatic charge image developing toner according to (((1))),
wherein the following expression (11) is satisfied,

0.7≤slope F(16). expression (11):

(((3)))

The electrostatic charge image developing toner according to (((1))) or (((2))),
wherein a content of the crystalline polyester resin is 10% by mass or more and 40% by mass or less with respect to the binder resin.
   (((4)))

The electrostatic charge image developing toner according to (((3))),
wherein a ratio Ws/Wc of a content Ws of the internally-added crosslinked resin particles to a content We of the crystalline polyester resin with respect to the toner particles is 0.13 or more and 1.50 or less in terms of mass ratio.
   (((5)))

The electrostatic charge image developing toner according to (((4))),
wherein the ratio Ws/Wc of the content Ws of the internally-added crosslinked resin particles to the content We of the crystalline polyester resin with respect to the toner particles is 0.25 or more and 1.25 or less in terms of mass ratio.
   (((6)))

The electrostatic charge image developing toner according to any one of (((1))) to (((5))),
wherein, in the cross-sectional observation of the toner particles, an area ratio of the internally-added crosslinked resin particles to a cross section of the toner particles is more than 15% and 48% or less.
   (((7)))

The electrostatic charge image developing toner according to any one of (((1))) to (((6))),
wherein the average dispersion size of the internally-added crosslinked resin particles is 120 nm or more and 250 nm or less.
   (((8)))

The electrostatic charge image developing toner according to any one of (((1))) to (((7))),
wherein a dielectric loss factor of a toner after being left to stand at a temperature of 28° C. and a relative humidity of 85% RH at 1 kHz is 35×10⁻³ or less.
   (((9)))

The electrostatic charge image developing toner according to any one of (((1))) to (((8))),
wherein the toner particles contain carbon black as a colorant.
   (((10)))

An electrostatic charge image developer comprising:
the electrostatic charge image developing toner according to any one of (((1))) to (((9))).
   (((11)))

A toner cartridge comprising:
a container that contains the electrostatic charge image developing toner according to any one of (((1))) to (((9))),
wherein the toner cartridge is detachable from an image forming apparatus.
   (((12)))

A process cartridge comprising:
a developing device that contains the electrostatic charge image developer according to (((10))) and develops an electrostatic charge image formed on a surface of an image holder as a toner image using the electrostatic charge image developer,
wherein the process cartridge is detachable from an image forming apparatus.
   (((13)))

An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to (((10))) and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.
   (((14)))

An image forming method comprising:
charging a surface of an image holder;
forming an electrostatic charge image on the charged surface of the image holder;
developing the electrostatic charge image formed on the surface of the image holder as a toner image using the electrostatic charge image developer according to (((10)));
transferring the toner image formed on the surface of the image holder to a surface of a recording medium; and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles that contain an amorphous polyester resin and a crystalline polyester resin as a binder resin and internally-added crosslinked resin particles,
wherein the internally-added crosslinked resin particles are styrene-(meth)acrylic copolymer particles in which a storage elastic modulus G′ in a range of 60° C. or higher and 100° C. or lower is 1×10⁵ Pa or more and 1×10⁶ Pa or less,
an average dispersion size of the internally-added crosslinked resin particles is 100 nm or more and 300 nm or less, and
in a case where a square region of 3 μm×3 μm having a size of 600 pix×600 pix in a cross-sectional observation of the toner particles is divided into n×n regions, in the n×n divided regions, the following expression (1) is satisfied from DAR(n) that is a coefficient of variation of an area ratio of the internally-added crosslinked resin particles to an area of the divided regions and slope F(16) that is a slope of an approximate straight line in a dispersion diagram obtained by changing the n to 3, 4, 6, 8, 12, and 16 and plotting log[1/n] on an X-axis and log[DAR(n)] on a Y-axis,
0.6≤slope F(16). expression (1):

2. The electrostatic charge image developing toner according to claim 1,
wherein the following expression (11) is satisfied,
0.7≤slope F(16). expression (11):

3. The electrostatic charge image developing toner according to claim 1,
wherein a content of the crystalline polyester resin is 10% by mass or more and 40% by mass or less with respect to the binder resin.

4. The electrostatic charge image developing toner according to claim 3,
wherein a ratio Ws/Wc of a content Ws of the internally-added crosslinked resin particles to a content We of the crystalline polyester resin with respect to the toner particles is 0.13 or more and 1.50 or less in terms of mass ratio.

5. The electrostatic charge image developing toner according to claim 4,
wherein the ratio Ws/Wc of the content Ws of the internally-added crosslinked resin particles to the content We of the crystalline polyester resin with respect to the toner particles is 0.25 or more and 1.25 or less in terms of mass ratio.

6. The electrostatic charge image developing toner according to claim 1,
wherein, in the cross-sectional observation of the toner particles, an area ratio of the internally-added crosslinked resin particles to a cross section of the toner particles is more than 15% and 48% or less.

7. The electrostatic charge image developing toner according to claim 1,
wherein the average dispersion size of the internally-added crosslinked resin particles is 120 nm or more and 250 nm or less.

8. The electrostatic charge image developing toner according to claim 1,
wherein a dielectric loss factor of a toner after being left to stand at a temperature of 28° C. and a relative humidity of 85% RH at 1 kHz is 35×10⁻³ or less.

9. The electrostatic charge image developing toner according to claim 1,
wherein the toner particles contain carbon black as a colorant.

10. An electrostatic charge image developer comprising:
the electrostatic charge image developing toner according to claim 1.

11. An electrostatic charge image developer comprising:
the electrostatic charge image developing toner according to claim 2.

12. An electrostatic charge image developer comprising:
the electrostatic charge image developing toner according to claim 3.

13. An electrostatic charge image developer comprising:
the electrostatic charge image developing toner according to claim 4.

14. An electrostatic charge image developer comprising:
the electrostatic charge image developing toner according to claim 5.

15. An electrostatic charge image developer comprising:
the electrostatic charge image developing toner according to claim 6.

16. An electrostatic charge image developer comprising:
the electrostatic charge image developing toner according to claim 7.

17. A toner cartridge comprising:
a container that contains the electrostatic charge image developing toner according to claim 1,
wherein the toner cartridge is detachable from an image forming apparatus.

18. A process cartridge comprising:
a developing device that contains the electrostatic charge image developer according to claim 10 and develops an electrostatic charge image formed on a surface of an image holder as a toner image using the electrostatic charge image developer,
wherein the process cartridge is detachable from an image forming apparatus.

19. An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to claim 10 and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image using the electrostatic charge image developer according to claim 10;
transferring the toner image formed on the surface of the image holder to a surface of a recording medium; and
fixing the toner image transferred to the surface of the recording medium.
